(19) United States
(12) Patent Application Publication
(10) Pub. No.: US 2014/0223292 A1
(43) Pub. Date: Aug. 7, 2014

(54) DISPLAY CONTROL DEVICE, DISPLAY METHOD, CONTROL PROGRAM, AND RECORDING MEDIUM

(71) Applicants: Makoto Sakuta, Osaka-shi (JP); Kazunori Ikeda, Osaka-shi (JP); Azusa Umemoto, Osaka-shi (JP)

(72) Inventors: Makoto Sakuta, Osaka-shi (JP); Kazunori Ikeda, Osaka-shi (JP); Azusa Umemoto, Osaka-shi (JP)

(73) Assignee: SHARP KABUSHIKI KAISHA, Osaka-shi, Osaka (JP)

(21) Appl. No.: 14/347,887

(22) PCT Filed: May 25, 2012
(86) PCT No.: PCT/JP2012/063558

§ 371 Date: Mar. 27, 2014

(30) Foreign Application Priority Data
Nov. 30, 2011 (JP) 2011-262802

(51) Int. Cl. G06F 17/21; G06F 3/0485

(52) U.S. Cl. CPC G06F 17/211; G06F 3/0485
USPC 715/252

(57) ABSTRACT

An electronic book reader (1) includes an enlargement processing section (20) which determines, with reference to article management information (30), a scroll direction of a component to be displayed in an enlarged manner, and causes the component to be displayed in an enlarged manner in an enlarged-display area in which scrolling in the scroll direction thus determined is possible.

### TECHNICAL FIELD

The present invention relates to a display control device or the like for displaying document content, components of which are scrolled in respective different scroll directions when displayed in an enlarged manner.

### BACKGROUND ART

In recent years, use of document content in the form of electronic data, such as an electronic book, is widely spreading. The document content is viewed on various terminals, and is often viewed on portable terminals such as a tablet terminal or a smart phone.

In a case where document content is viewed on a portable terminal, which has a relatively small display screen, the document content is often displayed in an enlarged manner so that letters are easier to read. However, in order to read the document content while the document content is displayed in an enlarged manner, it is necessary to repeat an operation of scrolling the screen.

In particular, in a case where document content such as newspaper is displayed in an enlarged manner, which document content is constituted by a vertically written component, a horizontally written component, a multicolumn component, and the like that are laid out irregularly together with a photograph, a chart, or the like, it is difficult to understand in which direction the screen should be scrolled in order to read an article. This degrades viewability and operability.

Techniques for addressing the above-described problems are disclosed in documents including, for example, Patent Literatures 1 and 2 as listed below. Other documents that are related to display of document content in which a plurality of components are laid out include Patent Literature 3, which is also listed below.

Patent Literature 1 describes content management in which content is divided into a title display block, an image display block, a text display block, and the like. Patent Literature further describes that, in a case of displaying a specified block in an enlarged manner on a terminal having a single screen, a region in which the block is drawn is deformed so that the block is scrolled in a single direction when displayed in an enlarged manner.

Patent Literature 2 listed below describes an electronic dictionary that displays a headword in an enlarged manner in a zoom window.

### CITATION LIST

### Patent Literatures

Patent Literature 1
Japanese Patent Application Publication, Tokukai, No. 2008-135024 A (Publication Date: Jun. 12, 2008)

Patent Literature 2
Japanese Patent Application Publication, Tokukai, No. 2006-331443 A (Publication Date: Dec. 7, 2006

Patent Literature 3
Japanese Patent Application Publication, Tokukaihei, No. 8-265556 A (Publication Date: Oct. 11, 1996)

### SUMMARY OF INVENTION

### Technical Problem

However, according to the technique described in Patent Literature 1, the region in which the block is displayed is deformed, so that the layout cannot be the same before and after the enlargement of the block. Further, while content such as newspaper allows determining, for example, whether a component is a big headline or a subheading depending on a character size of the component, such a determination is difficult to make in a case where only a specific block is enlarged as in Patent Literature 1. That is, in layout display of content, a character size of the content displayed is one of the elements of the layout. As such, enlarging only part of blocks constituting the content ultimately results in a change in the layout before and after the enlargement.

In contrast, with the zoom window described in Patent Literature 2, a layout of a document to be enlarged is unchanged. However, with a window like this which is fixed in size, document content that is constituted by a vertically written component, a horizontally written component, a multicolumn component, and the like, which are irregularly laid out together with a photograph, a chart, or the like, cannot be easily displayed in an enlarged manner while being easy to view.

The present invention is accomplished in view of the problem. An object of the present invention is to provide a display control device or the like which allows a component, which is to be displayed in an enlarged manner among components of the document content, to be displayed in an enlarged manner so as to be viewed while being scrolled in a predetermined scroll direction, without affecting an original layout of the document content.

### Solution to Problem

In order to attain the object, a display control device of the present invention is a display control device which displays part of a plurality of components of document content in an enlarged manner, including: scroll direction determining means for determining, with reference to scroll information, a scroll direction of a component to be displayed in an enlarged manner, the scroll information being indicative of a scroll direction in which each of the plurality of components is scrolled when displayed in an enlarged manner; and enlargement processing means for causing the component, which is to be displayed in an enlarged manner, to be displayed in an enlarged manner in an enlarged-display area in which scrolling in the scroll direction determined by the scroll direction determining means is possible, among one or a plurality of enlarged-display areas which are different from a layout display area in which layout display of the plurality of components is performed.

In order to attain the object, a display method of the present invention is a display method for displaying a part of a plurality of components of document content in an enlarged manner by use of a display control device, the method including the steps of: (a) determining, with reference to scroll information, a scroll direction of a component to be displayed in an enlarged manner, the scroll information being indicative of a scroll direction in which each of the plurality of components is scrolled when displayed in an enlarged manner; and (b) causing the component, which is to be displayed in an enlarged manner, to be displayed in an enlarged manner in an enlarged-display area in which scrolling in the scroll direction determined in the step (a) is possible, among one or a plurality of enlarged-display areas which are different from a layout display area in which layout display of the plurality of components is performed.

According to the configuration, a scroll direction of a component, to be displayed in an enlarged manner, of document content is determined with reference to scroll information which is indicative of a scroll direction in which each of a plurality of components of the document content is scrolled when displayed in an enlarged manner.

Then, the component to be displayed in an enlarged manner is displayed in an enlarged manner in an enlarged-display area in which the component can be scrolled in the determined scroll direction, among one or a plurality of enlarged-display areas which are different from a layout display area in which layout display of the plurality of components is performed. For example, in a case where the scroll direction of the component to be displayed in an enlarged manner is a vertical direction (up-and-down direction), the component is displayed in an enlarged manner in an enlarged-display area in which the component can be scrolled in the vertical (up-and-down) direction. In a case where the scroll direction is a horizontal direction (right-and-left direction), the component is displayed in an enlarged manner in an enlarged-display area in which the component can be scrolled in the horizontal direction (right-and-left direction).

Therefore, according to the configuration, the component to be displayed in an enlarged manner can be displayed in an enlarged manner so as to be viewed by being scrolled in a predetermined scroll direction. Further, since the enlarged-display area is an area different from the layout display area, an original layout of the document content is not affected by the enlarged display.

### Advantageous Effects of Invention

As described above, the display control device of the present invention includes: scroll direction determining means for determining, with reference to scroll information, a scroll direction of a component to be displayed in an enlarged manner, the scroll information being indicative of a scroll direction in which each of the plurality of components is scrolled when displayed in an enlarged manner; and enlargement processing means for causing the component, which is to be displayed in an enlarged manner, to be displayed in an enlarged manner in an enlarged-display area in which scrolling in the scroll direction determined by the scroll direction determining means is possible, among one or a plurality of enlarged-display areas which are different from a layout display area in which layout display of the plurality of components is performed.

As described above, the display method of the present invention includes the steps of: (a) determining, with reference to scroll information, a scroll direction of a component to be displayed in an enlarged manner, the scroll information being indicative of a scroll direction in which each of the plurality of components is scrolled when displayed in an enlarged manner; and (b) causing the component, which is to be displayed in an enlarged manner, to be displayed in an enlarged manner in an enlarged-display area in which scrolling in the scroll direction determined in the step (a) is possible, among one or a plurality of enlarged-display areas which are different from a layout display area in which layout display of the plurality of components is performed.

Therefore, the component to be displayed in an enlarged manner can be displayed in an enlarged manner so as be viewed by being scrolled in a predetermined scroll direction. Further, since the enlarged-display area is an area different from the layout display area, the original layout of the document content is not affected by the enlarged display.

### BRIEF DESCRIPTION OF DRAWINGS

FIG. 1 is a view illustrating an embodiment of the present invention, and is a block diagram illustrating a configuration of main parts of an electronic book reader.

FIG. 2 is a view illustrating article management information for allowing the electronic book reader to manage document content in terms of articles.

FIG. 3 is a view illustrating a related chart list for allowing the electronic book reader to display a related chart.

FIG. 4 is a view illustrating article management information and a related chart list that are for allowing the electronic book reader to associate a related chart with an image block.

FIG. 5 is a view illustrating a headline list for allowing the electronic book reader to cause a headline of an article to be displayed with a mark.

FIG. 6 is a view illustrating an example of an enlarged display screen of an image block to be scrolled in an up-and-down direction.

FIG. 7 is a view illustrating an example of an enlarged display screen of an image block to be scrolled in a right-and-left direction.

FIG. 8 is a view illustrating an example of a screen where enlarged display is simultaneously carried out in both a vertical scroll area and a horizontal scroll area.

FIG. 9 is a view illustrating an example of a screen in which a related chart is displayed.

FIG. 10 is a view illustrating an example of a screen in which the headline is displayed with a mark.

FIG. 11 is a flowchart showing an example of a process for carrying out enlarged display in either one of a vertical scroll area and a horizontal scroll area.

FIG. 12 is a flowchart showing an example of a process for carrying out enlarged display both in a vertical scroll area and a horizontal scroll area simultaneously.

FIG. 13 is a flow chart showing an example of a process for carrying out related chart display in which a related chart that is related to an image block being displayed in an enlarged manner is displayed.

FIG. 14 is a flow chart showing an example of a process for moving a position of an enlargement region, in which process the position of the enlargement region is moved by a flicking operation.

FIG. 15 is a flowchart showing an example of a scroll process in which an enlargement region is automatically scrolled.

FIG. 16 is a flowchart showing an example of an article transition process in which a transition of an image block to be enlarged to an image block of another group ID or to an image block of another article is carried out by moving a position of an enlargement region.

FIG. 17 is a flowchart showing an example of an article transition process in which a transition of a subject to be enlarged to another article is made by a tapping operation.

FIG. 18 is a flowchart showing an example of a headline marking process in which a headline of an article being displayed in an enlarged manner is displayed with a mark.

FIG. 19 is a view illustrating an example of text layout information for displaying text-based document content.

FIG. 20 is a view illustrating an example of image layout information for displaying an image together with a text displayed on the basis of the text layout information.

### DESCRIPTION OF EMBODIMENTS

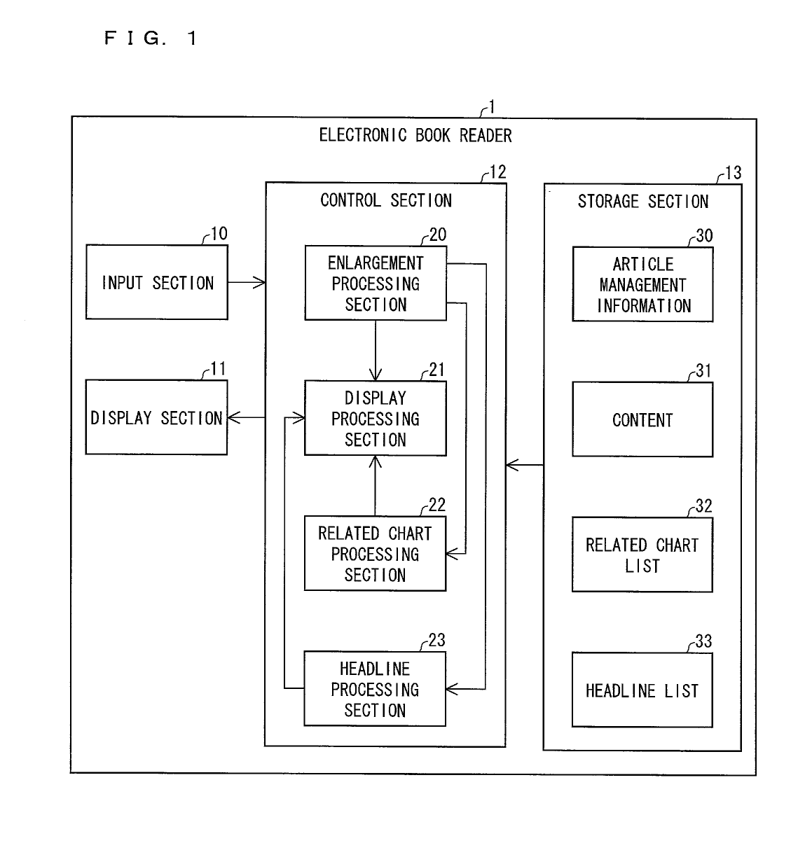

The following description will discuss details of an embodiment of the present invention with reference to FIGS. 1 through 20.

[Configuration of Electronic Book Reader]

First, the following description will discuss, with reference to FIG. 1, a configuration of an electronic book reader in accordance with the present embodiment. FIG. 1 is a block diagram illustrating a configuration of main parts of an electronic book reader (display control device) 1. As illustrated in FIG. 1, the electronic book reader 1 includes an input section 10, a display section 11, a control section 12, and a storage section 13.

The electronic book reader 1 is an electronic device which allows a user to view document content such as an electronic book. For example, the electronic book reader 1 displays page layout-type document content such as PDF (Portable Document Format). Note that document content to be displayed is not limited to one in the PDF format, and may be one in other formats such as TIFF and JPEG. Further, the electronic book reader may be one that displays reflow-type document content.

The electronic book reader 1 allows a user to easily read content of documents, such as pages of newspapers or magazines, in which vertically written content, horizontally written content, multi-column content are intricately combined, while allowing the user to cause the electronic book reader 1 to display each article of such document content in an enlarged manner.

The input section 10 receives an input operation given by the user of the electronic book reader 1, and transmits the input operation to the control section 12. The display section 11 is controlled by the control section 12 to display an image. The following description will discuss an example in which the input section 10 and the display section 11 are implemented as a touch panel. Note that the input section 10 and the display section 11 may be a device which is provided independent of and external to the electronic book reader 1.

The control section 12 controls functions of the electronic book reader 1 as a whole, and includes an enlargement processing section (scroll direction determining means, enlargement processing means, focus processing means) 20, a display processing section 21, and a related chart processing section (related image processing means) 22, and a headline processing section (headline processing means) 23.

The enlargement processing section 20 causes a component of the document content to be displayed in an enlarged manner in an enlarged-display area. The details of enlarged display will be discussed later. However, briefly, when enlarged display is to be carried out, the enlargement processing section 20 determines a scroll direction of a component which is to be displayed in an enlarged manner, and in accordance with a result of the determination, carries out enlarged display in a predetermined enlarged-display area.

The display processing section 21 carries out a process of causing the display section 11 to display the document content, as well as a process of enlarging, reducing, or scrolling the displayed document content.

The related chart processing section 22 carries out a process of causing a chart (hereinafter, referred to as a related chart) related to an article that is being displayed in an enlarged manner, from among charts included in the document content. The process for causing the related chart will be discussed later in detail.

The storage section 13 stores various data used by the electronic book reader 1. The storage section 13 stores article management information (scroll information, article identification information, display order information, summary identification information) 30, content (document content) 31, and a related chart list (associated-image information) 32, and a headline list (headline identification information) 33.

Note that, although the present embodiment describes an example in which the storage section 13 is built in the electronic book reader 1, the present embodiment is not limited to the example as long as the data stored in the storage section 13 can be read out by the electronic book reader 1. For example, the storage section 13 may be provided external to the electronic book reader 1, or be present in a server or the like which is capable of communicating with the electronic book reader 1.

The article management information 30 is used to manage document content in terms of articles, and includes at least scroll information that indicates a scroll direction of each component of the document content for a case where the component of the document content being displayed in an enlarged manner is being read. The enlargement processing section 20 determines the enlarged-display area with use of the scroll information.

In addition to the above, the article management information 30 includes article identification information that indicates an article to which each component of the document content belongs, display order information that indicates the display order of each component of the document content, etc. Such information will be discussed later.

The content 31 is an object to be displayed on the display section 11. The following will discuss an example in which the content 31 is page-layout type document content, or more specifically, a page of a newspaper in the PDF format.

The related chart list 32 is a list which indicates a chart related to an article in the document content and a position where the related chart is provided. The related chart processing section 22 causes the related chart to be displayed with use of the related chart list 32. Note that details of contents of the related chart list 32, display of the related chart in accordance with the contents of the related chart list 32 will be described later.

The headline list 33 is a list that indicates a headline of an article in the document content and a position where the headline is provided. The headline processing section 23 causes the headline to be displayed with a mark, with use of the headline list 33. Please note that details of contents of the headline list 33 and display of the headline with a mark in accordance with the contents of the headline list 33 will be described later.

[Details of Article Management Information]

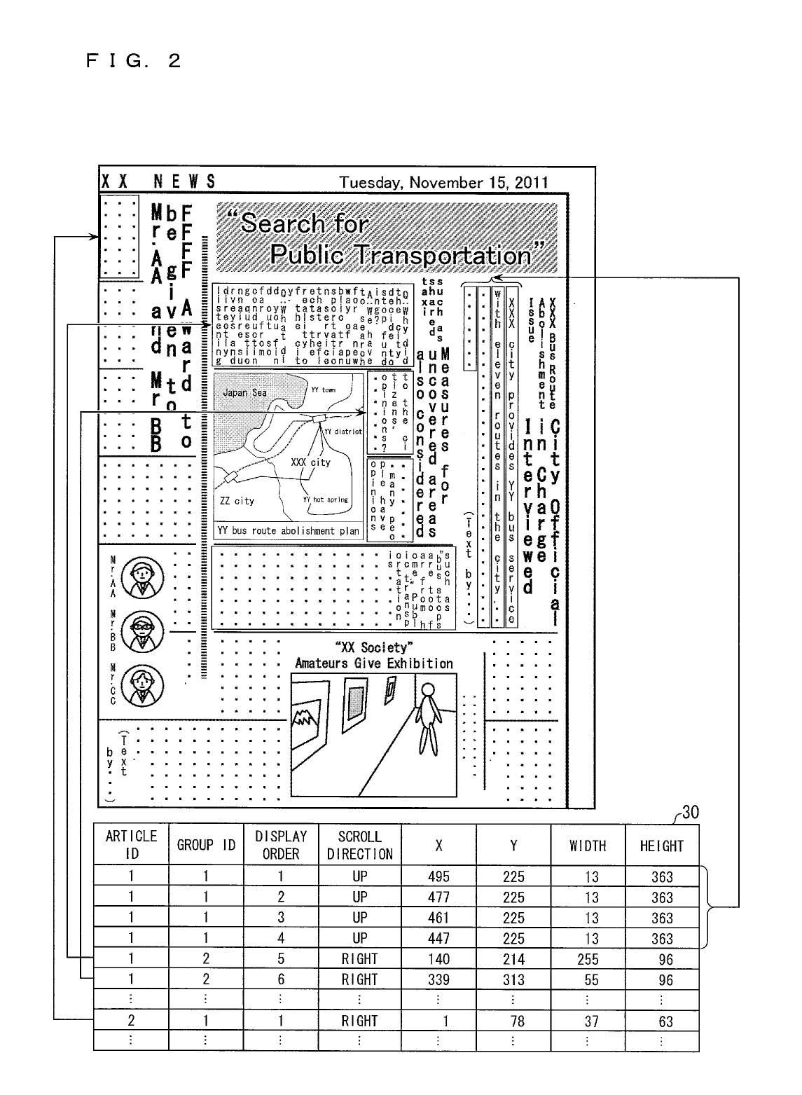

Next, the following description will discuss, with reference to FIG. 2, details of the article management information 30. FIG. 2 is a view illustrating the article management information 30. The article management information 30 illustrated in FIG. 2 is information in a table format in which the following eight elements are associated with one another: article ID (article identification information), group ID (summary identification information), display order (display order information), scroll direction (scroll information), X, Y, width, and height. Needless to say, the format of the article management information 30 is not limited to the table format.

The above elements each are associated with a corresponding image block which is one component of an image of the document content (in the present case, a newspaper). For example, the elements in the top four lines of the article management information 30 illustrated in FIG. 2 is associated with an image block including lines constituting a document component including four vertically written lines that starts with “XXX city provides . . . ” in the newspaper.

The article ID is identification information assigned to each article included in the document content. Image blocks belonging to one article is associated with an identical article ID. In other words, the article ID indicates an article to which each image block belongs.

The group ID is identification information assigned to a group of image blocks. In the document content like the newspaper, one article includes the following components: “headline”, “summary”, “details”, and “related chart(s) (photo(s))”, etc. These components each are different from each other in format such as a vertically written format, a horizontally written format, or a multi-column format. The group ID is assigned to such components of the document content. In other words, the group ID makes it possible to determine whether or not an image block is associated with details of the article, whether or not an image block is associated with a summary of the article, etc.

The display order indicates the display order of the image blocks. In the example illustrated in FIG. 2, the display order of a block to be displayed earlier is given a smaller value. More specifically, for each article, the display order of 1 is given to an image block to be displayed first, and each subsequent image block is given the display order whose value is incremented by 1 with respect to the display order of an immediately preceding image block. The electronic book reader 1 displays the image block in an enlarged manner according to this display order.

The scroll direction indicates a scroll direction at the time when an image block is displayed in an enlarged manner. That is, in the example illustrated in FIG. 2, an image block whose scroll direction is “UP” is an image block to be read by scrolling up at the time when the image block is displayed in an enlarged manner. Similarly, an image block whose scroll direction is “RIGHT” is an image block to be read by scrolling to the right at the time when the image block is displayed in an enlarged manner.

X and Y are information that indicates a position of an image block. In the example illustrated in FIG. 2, X and Y are coordinate values that indicate a position of an upper left apex of a rectangular shape of the image block relative to an origin (0,0) which is located at an upper left corner of a screen. For example, an X value and a Y value of an image block whose display order is one (1) indicate that the image block has coordinate values (495, 225). Note that coordinate values correspond to the number of dots in the screen. For example, a point having coordinate values (10, 10) corresponds to a dot that is ten dots to the right and ten dots down from the upper left corner of the screen.

Width and height are information which indicates a size of an image block. In the example illustrated in FIG. 2, a width and a height indicate the number of dots. For example, FIG. 2 shows that the image block whose display order is one (1) has a size with a width of 13 dots and a height of 363 dots. The values of X, Y, width, and height specify a region which the image block occupies in the screen.

For example, it is specified that the image block whose display order is two has an upper left apex with coordinate values (477, 225) and a size with a width of 13 dots and a height of 363 dots. It is thus specified that the line occupies a rectangular region defined by opposite apexes (477, 225) and (490, 588) on the screen.

[Details of Related Chart List]

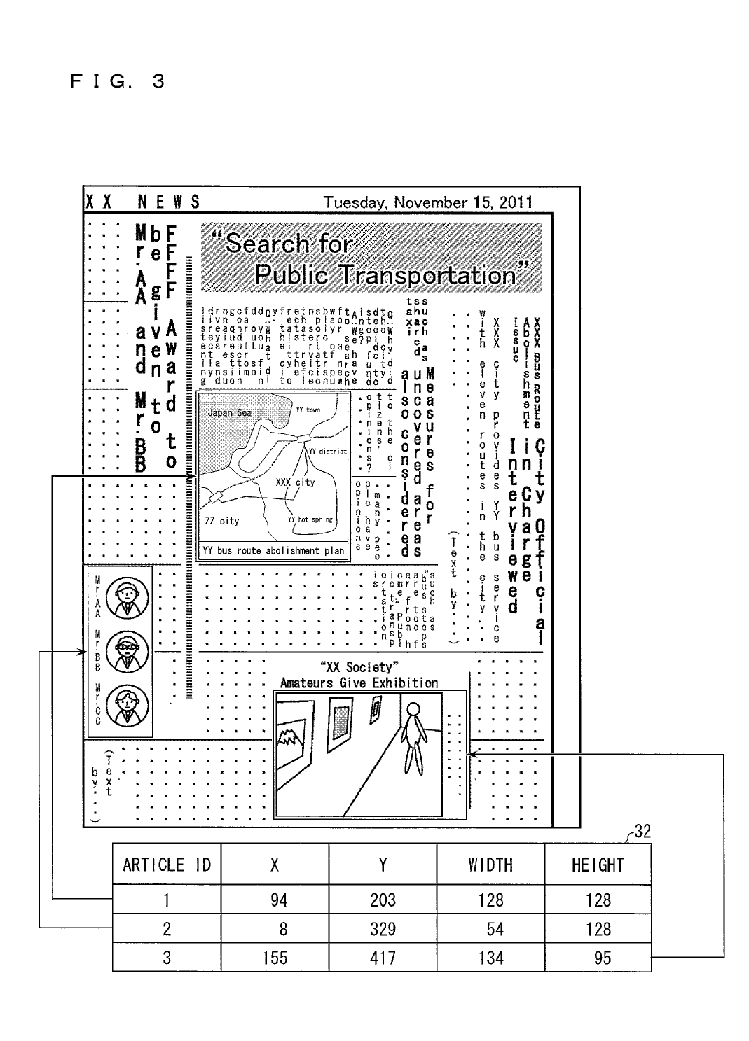

Next, the following description will discuss, with reference to FIG. 3, details of the related chart list 32. FIG. 3 is a view illustrating the related chart list 32. The related chart list 32 illustrated in FIG. 3 is information in a table format in which each article-related chart such as a drawing, a photo, or the like included in the document content is associated with five elements including article ID, X, Y, width, and height. Needless to say, the format of the chart related list 32 is not limited to the table format.

The article ID is identical to that in the article management information 30. In other words, in the related chart list 32 of FIG. 3, a related chart is associated in terms of articles. Note that because the article is constituted by image blocks, the related chart list 32 can also be said to be a list in which a related chart is associated with a corresponding image block.

X and Y are information which indicates a position of a related chart. In an example illustrated in FIG. 3, X and Y indicate coordinate values of an upper left apex of a rectangular shape in which the related chart is contained. For example, in the example illustrated in FIG. 3, an X value and a Y value indicate that the coordinate values are (94, 203) in the case of a chart whose article ID is one (1).

Width and height are information which indicates a size of a related chart. In the example illustrated in FIG. 3, a width and a height indicate the number of dots. For example, in the example illustrated in FIG. 3, it is shown that the related chart whose article ID is one (1) has a size with a width of 128 dots and a height of 128 dots. That is, it is specified that this chart occupies a rectangular region that is defined by an upper left apex (94, 203) and an apex (222, 331) opposite to the upper left apex.

By using such a related chart list 32, it becomes possible to specify a region occupied on an image by the related chart that is included in an article having each article ID. Therefore, the use of the related chart list 32 makes it possible to cut out and display an image of a related chart for an article while the article is being displayed in an enlarged manner.

[Another Example of Article Management Information and Related Chart List]

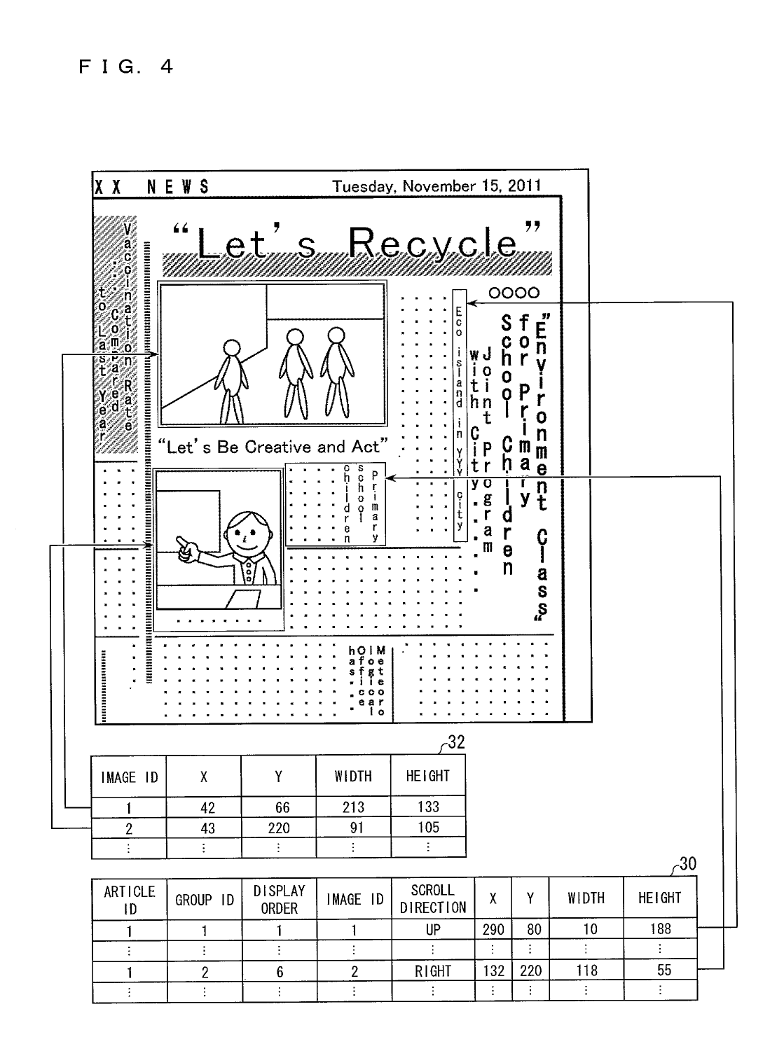

The related chart list 32 of FIG. 3 is a list in which a related chart is associated with a corresponding article ID. It is alternatively possible to associate the related chart with a corresponding image block. The following discusses this case with reference to FIG. 4. FIG. 4 is a view illustrating article management information 30 and a related chart list 32 that are for associating a related chart with an image block.

In the related chart list 32 illustrated in FIG. 4, an “image ID” that is an identifier for specifying an image is associated in place of the article ID of the related chart list 32 of FIG. 3. Further, in the article management information 30 of FIG. 4, an element “image ID” is associated in addition to the elements of the article management information of FIG. 2.

In other words, with reference to the article management information 30 of FIG. 4, it is possible to specify an image ID associated with each image block. Then, with reference to the related chart list 32 of FIG. 4, it is possible to specify a position of a related chart (drawing etc.) associated with the specified image ID. This makes it possible to cut out and display the related chart. In this way, in an example of FIG. 4, an image block is associated by the image ID with a related chart corresponding to the image block.

For example, in the article management information 30 of FIG. 4, the image ID “1” is associated with an image block whose display order is one (1). Further, in the related chart list 32 of FIG. 4, a position of the related chart whose image ID is one (1) is described. This makes it possible to display the related chart whose image ID is one (1) at a timing when the image block whose display order is one (1) is displayed in an enlarged manner, with use of the article management information 30 and the related chart list 32 of FIG. 4.

As described above, the article management information 30 and the related chart list 32 of FIG. 4 make it possible to narrow down the timing at which the related chart is displayed, unlike a case where the related chart list 32 of FIG. 3 is used. In other words, it becomes possible to display a related chart at a timing when an image block deeply related to the related chart is displayed.

[Details of Related Headline List]

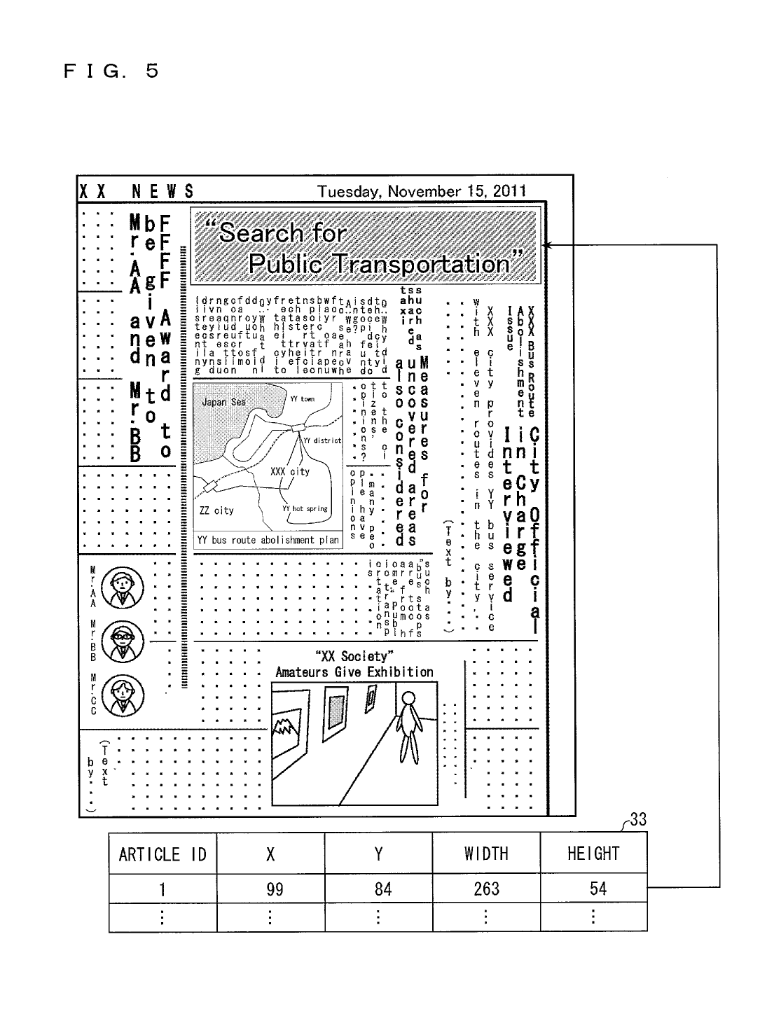

Next, the following description will discuss, with reference to FIG. 5, details of the headline list 33. FIG. 5 is a view illustrating the headline list 33. The headline list 33 illustrated in FIG. 5 is information in a table format in which five elements including article ID, X, Y, width, and height are associated with one another for each headline included in the document content. Needless to say, the format of the headline list 33 is not limited to the table format.

The article ID is identical to that in the article management information 30 and the related chart list 32. In other words, the headline list 33 of FIG. 5 shows a headline of each article.

X and Y are information which indicates a position of a headline. In an example illustrated in FIG. 5, X and Y indicate coordinate values of an upper left apex of a rectangular shape in which the headline is contained. For example, in the example illustrated in FIG. 5, an X value and a Y value indicate that the coordinate values are (99, 84) in the case of a headline whose article ID is one (1).

Width and height are information which indicates a size of a headline. In the example illustrated in FIG. 5, a width and a height indicate the number of dots. For example, in the example illustrated in FIG. 5, it is shown that the headline whose article ID is one (1) has a size with a width of 263 dots and a height of 54 dots. That is, it is specified that this headline occupies a rectangular region that is defined by an upper left apex (99, 84) and an apex (362, 138) opposite to the upper left apex.

By using such a headline list 33, it becomes possible to specify a region occupied on an image by the headline included in an article having each article ID. Therefore, the use of the headline list 33 makes it possible to put a mark on the region. This further makes it possible to clearly show a user a headline of an article that is being displayed in an enlarged manner.

[Examples of Enlarged Display (Individual Display)]

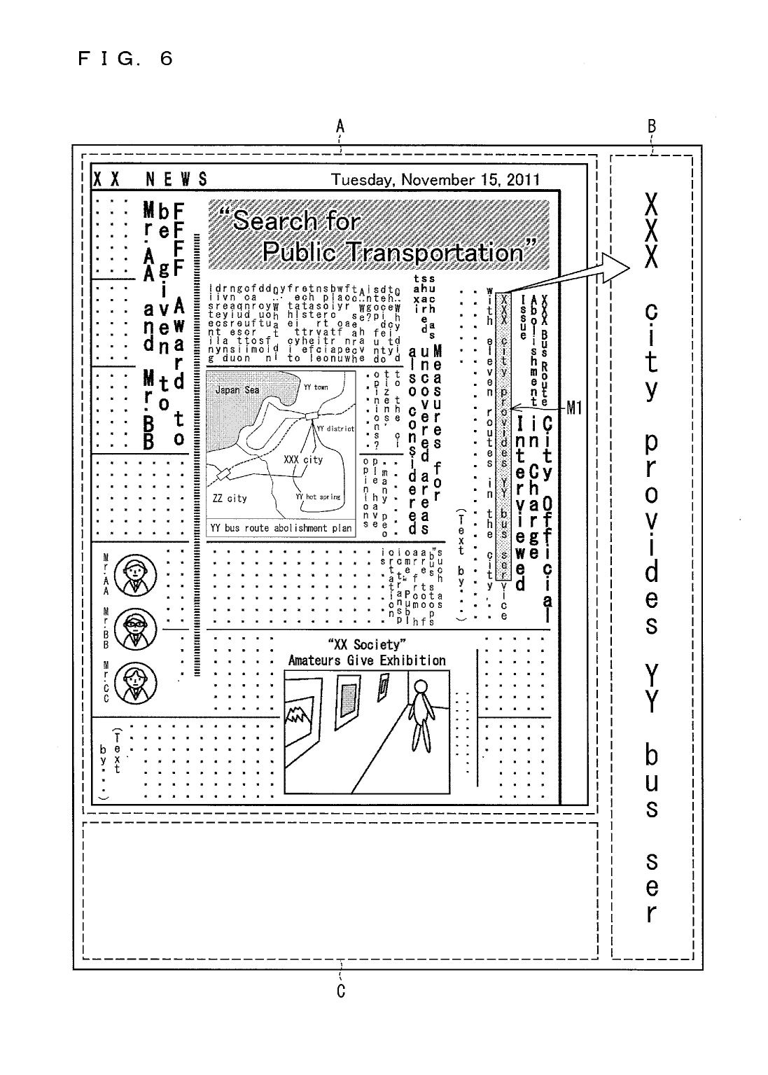

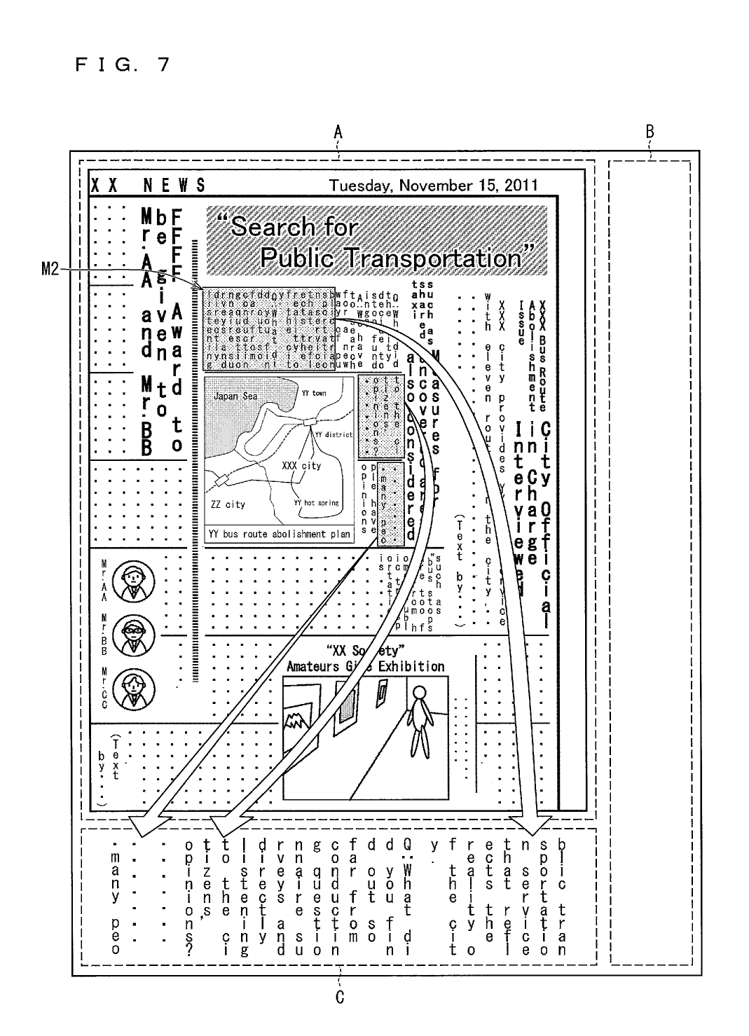

Next, the following description will discuss examples of enlarged display carried out by the electronic book reader 1, with reference to FIGS. 6 and 7. FIG. 6 illustrates one example of an enlarged display screen of an image block to be scrolled in an up-and-down direction. FIG. 7 illustrates one example of an enlarged display screen of an image block to be scrolled in a right-and-left direction.

The screens of FIGS. 6 and 7 each can be divided into the following three areas: a page display area (layout display area) A, a vertical scroll area (enlarged-display area) B, and a horizontal scroll area (enlarged-display area) C.

In the examples illustrated in FIGS. 6 and 7, the vertical scroll area B is disposed on the right side of the page display area A, while the horizontal scroll area C is disposed below the page display area A. The present invention is not limited to these examples. However, as described later, these scroll areas each serve as an area that receives an operation for scrolling an enlarged display. Therefore, these scroll areas are preferably disposed on fringes of the screen in consideration of operability. In other words, preferably, the vertical scroll area B is disposed on the right or left side of the page display area A, while the horizontal scroll area C is disposed above or below the display area A.

The electronic book reader 1 displays in an enlarged manner an image block to be scrolled in the up-and-down direction (in a vertical direction), in the vertical scroll area B whose length direction coincides with the vertical direction (see FIG. 6). Meanwhile, the electronic book reader 1 displays in an enlarged manner an image block to be scrolled in the right-and-left direction (in a horizontal direction), in the horizontal scroll area C whose length direction coincides with the horizontal direction (see FIG. 7).

As described above, the electronic book reader 1 carries out enlarged display in an area corresponding to a scroll direction of an image block. Accordingly, the image block displayed in an enlarged manner is easily viewed and also easily scrolled. Note that a scroll direction of an image block can be specified by the above-described article management information 30.

In the page display area A, a whole or a part of the document content is displayed. This allows a user to check a layout of the whole document content. Further, the user can select an article to be displayed in an enlarged manner, by a tapping operation (an operation of touching with a finger or the like for a short time) in the page display area A. Furthermore, the user also can flip pages by carrying out a flicking operation (an operation of sliding a finger in touching with the display surface and then separating the finger away from the display surface) in the page display area A.

As described above, in the vertical scroll area B, an image block to be scrolled in the up-and-down direction is displayed in an enlarged manner, while in the horizontal scroll area C, an image block to be scrolled in the right-and-left direction is displayed in an enlarged manner. Note that respective positions of the vertical scroll area B and the horizontal scroll area C are preferably fixed on the screen. This is because, in a case where the respective positions of the vertical scroll area B and the horizontal scroll area C are not fixed on the screen, operability deteriorates and consequently, movement of user's eyes becomes wider.

A flicking operation in either one of the vertical scroll area B and the horizontal scroll area C makes it possible to make the enlargement region to advance further or go back in the document content. More specifically, by carrying out a flicking operation in the up-and-down direction in either one of the vertical scroll area B and the horizontal scroll area C, the enlargement region of the vertical scroll area B can be moved (scrolled) in the up-and-down direction. Similarly, by carrying out a flicking operation in the right-and-left direction in either one of the vertical scroll area B and the horizontal scroll area C, the enlargement region of the horizontal scroll area C can be moved (scrolled) in the right-and-left direction.

In other words, the vertical scroll area B is an area where an image displayed in an enlarged manner can be scrolled in the vertical direction, while the horizontal scroll area C is an area where an image displayed in an enlarged manner can be scrolled in the horizontal direction.

Further, the enlargement region can be automatically scrolled by a tapping operation in either of the vertical scroll area B or the horizontal scroll area C. By automatic scrolling, the document content can be read further without repeatedly carrying out the flicking operation.

After the enlargement region is scrolled to the end of the image block, the electronic book reader 1 makes a transition of the enlargement region to the beginning of a subsequent image block. Then, after the enlargement region is scrolled to the end of the last image block of one group of an article, the electronic book reader 1 makes a transition of the enlargement region to the beginning of an image block of a subsequent group of the same article. Furthermore, after the enlargement region is scrolled to the end of one article, the electronic book reader 1 makes a transition of the enlargement region to the beginning of a subsequent article.

This allows a user to read articles only by a flicking operation in the vertical or horizontal direction. Further, because such flicking operations can be made in both the vertical scroll area B and the horizontal scroll area C, for example, it is possible to read articles only with one finger or a thumb of a hand holding the electronic book reader 1.

For example, by making an upward flicking operation in the example of FIG. 6, the enlargement region can be scrolled so that the user can read text in four vertically written lines that start with “XXX City provides . . . ”. Then, by further making an upward flicking operation in a state where the end of the text is displayed in an enlarged manner, it is possible to make a transition of the enlargement region to an image block made of multiple columns that starts with “Q: Why did the city . . . ”.

Note that because this image block is an image block to be scrolled in the right-and-left direction, the image displayed in an enlarged manner in the vertical scroll area B is cleared and this image block is displayed in an enlarged manner in the horizontal scroll area C. Needless to say, the image displayed in an enlarged manner in the vertical scroll area B may be kept displayed as it is. However, when the enlarged display is carried out in only one scroll area, the user does not need to find out which scroll area the user should view. In other words, the above arrangement advantageously allows the user to read the document content only by following the scroll area being displayed in an enlarged manner.

Further, in the example of FIG. 6, the page display area A has a mark M1 displayed at a part corresponding to the image being displayed in an enlarged manner in the vertical scroll area B. This allows the user to easily recognize a position where the part being displayed in an enlarged manner is displayed on a page layout of the document content.

Similarly, in the example of FIG. 7, the page display area A has a mark M2 displayed at a part corresponding to the image being displayed in an enlarged manner in the horizontal scroll area C. This mark M2 is extended over a plurality of columns. As is clear from this, the electronic book reader 1 displays in an enlarged manner a region extending over a plurality of columns (or rows) that can be displayed within the horizontal scroll area C (or the vertical scroll area B).

[Example of Enlarged Display (Simultaneous Display)]

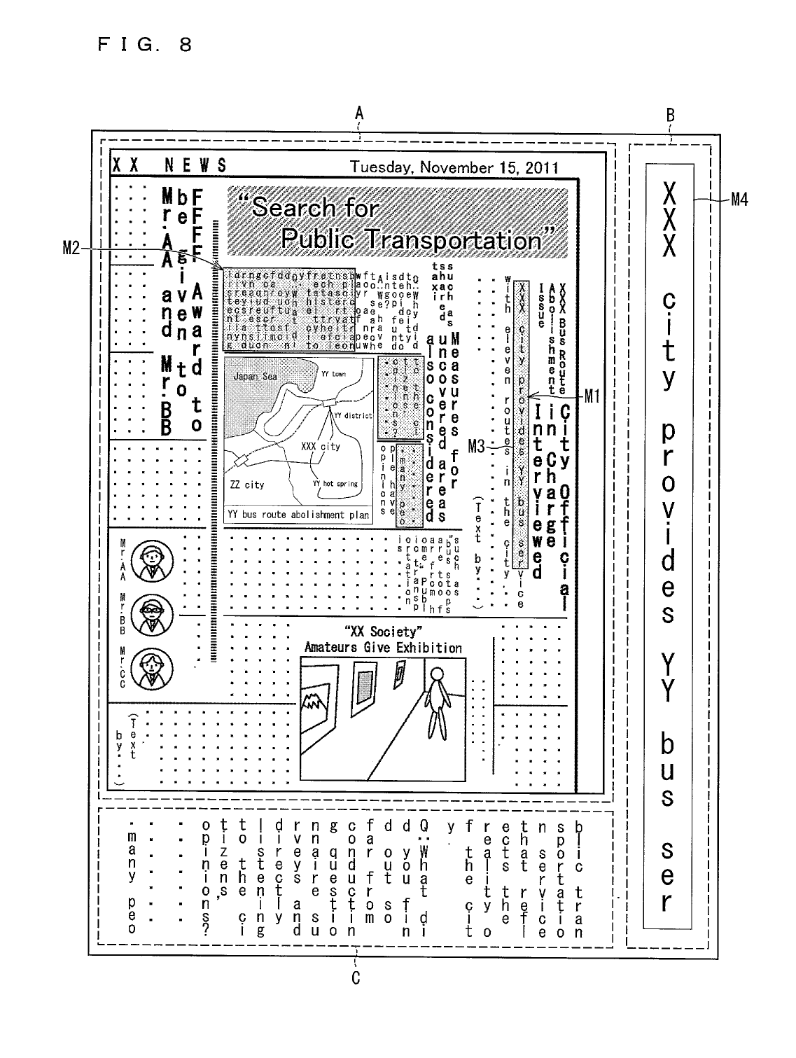

FIGS. 6 and 7 each illustrate an example case where enlarged display is carried out only in either one of the vertical scroll area B and the horizontal scroll area C. The following discusses an example case where enlarged display is simultaneously carried out in both the vertical scroll area B and the horizontal scroll area C, with reference to FIG. 8. FIG. 8 is a view illustrating an example of a screen where enlarged display is simultaneously carried out in both the vertical scroll area B and the horizontal scroll area C.

As illustrated in FIG. 8, a summary of an article whose headline reads “Search for Public Transportation” is displayed in an enlarged manner in the vertical scroll area B, while details of this article is displayed in an enlarged manner in the horizontal scroll area C. This allows a user to read both the summary and the details of the article in the vertical scroll area B and the horizontal scroll area C, respectively, while allowing the user to check a layout of the article in the page display area A.

Further, in the example of FIG. 8, the summary is displayed in an enlarged manner on the right side of the screen, while the details are displayed in an enlarged manner on the left side of the screen. This layout is similar to that in the page display area A. Accordingly, the user have less discomfort when reading the text displayed in an enlarged manner.

Further, in the example of FIG. 8, the page display area A has a mark M1 displayed at a part corresponding to the image being displayed in an enlarged manner in the vertical scroll area B and a mark M2 displayed at a part corresponding to the image being displayed in an enlarged manner in the horizontal scroll area C. These marks each are preferably in an aspect that shows a corresponding scroll area in the page display area A. For example, the marks may be arranged so that the color of the mark M1 and the background color of the vertical scroll area B are identical to each other, while the color of the mark M2 and the background color of the horizontal scroll area C are identical to each other.

In addition, in the example of FIG. 8, a mark M3 is displayed together with the mark M1 in the page display area A. Further, a mark M4 is displayed in the vertical scroll area B where the part provided with the mark M3 is displayed in an enlarged manner.

These marks each are for focusing a part that is assumed to be a part that the user is currently reading. The marks are updated according to a user operation or the like. This allows the user to read an article by following the part with the mark. Hereinafter, the marks M3 and M4 are called a main focus. The main focus is provided for the purpose of showing a scroll area to be focused by the user between the vertical scroll area B and the horizontal scroll area C. As long as this purpose is achieved, the main focus may be in any aspect. For example, in one aspect, the mark M4 may arranged to have a higher display luminance in either one of the vertical scroll area B or the horizontal scroll area C than in the other.

Note that in a case where enlarged display is simultaneously carried out in both the vertical scroll area B and the horizontal scroll area C, the user may be confused if enlarged images of different articles are simultaneously displayed. Therefore, in such a case, it is desirable to have only image blocks having an identical article ID as objects to be displayed in an enlarged manner. For example, assume a case where, while an article is being displayed in an enlarged manner, a user operation to display another article is received. In such a case, it is preferable to clear the article being displayed in an enlarged manner and display the another article in an enlarged manner.

There are advantages respectively in a case where enlarged display is carried out in only one of the vertical scroll area B and the horizontal scroll area C and in a case where enlarged display is carried out in both the vertical scroll area B and the horizontal scroll area C. Therefore, it is preferable to allow the user to select whether to carry out enlarged display in one or both of the vertical scroll area B and the horizontal scroll area C.

[Example of Display of Related Chart]

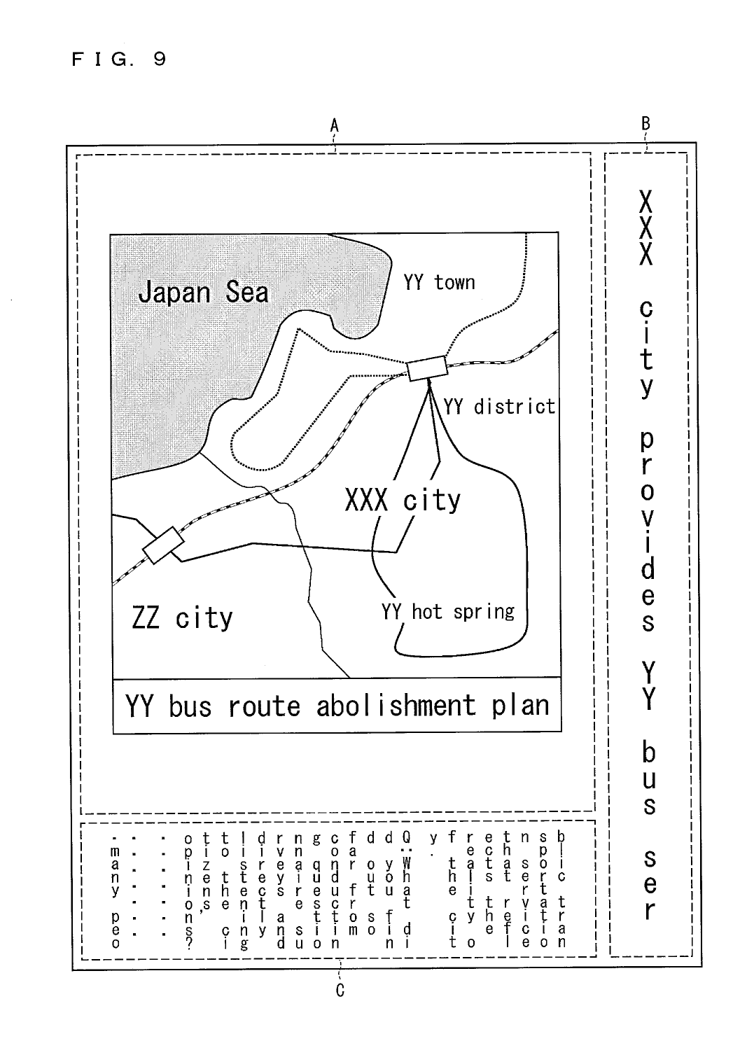

Next, the following discusses display of a related chart of an article being displayed in an enlarged manner, with reference to FIG. 9. FIG. 9 is a view illustrating an example of a screen in which a related chart is displayed.

In the example illustrated in FIG. 9, in the page display area A, not the entire document content but a related chart is displayed. This related chart is relevant to an article being displayed in an enlarged manner. As described with reference to FIG. 3, it is possible to carry out the display with use of the related chart list 32.

The above display allows a user to check all the abstract, the details, and the related chart of the document content in one screen. Note that it is preferable to allow the user to switch between display of the entire document content and display of the related chart in the page display area A.

[Example of Display of Mark on Headline]

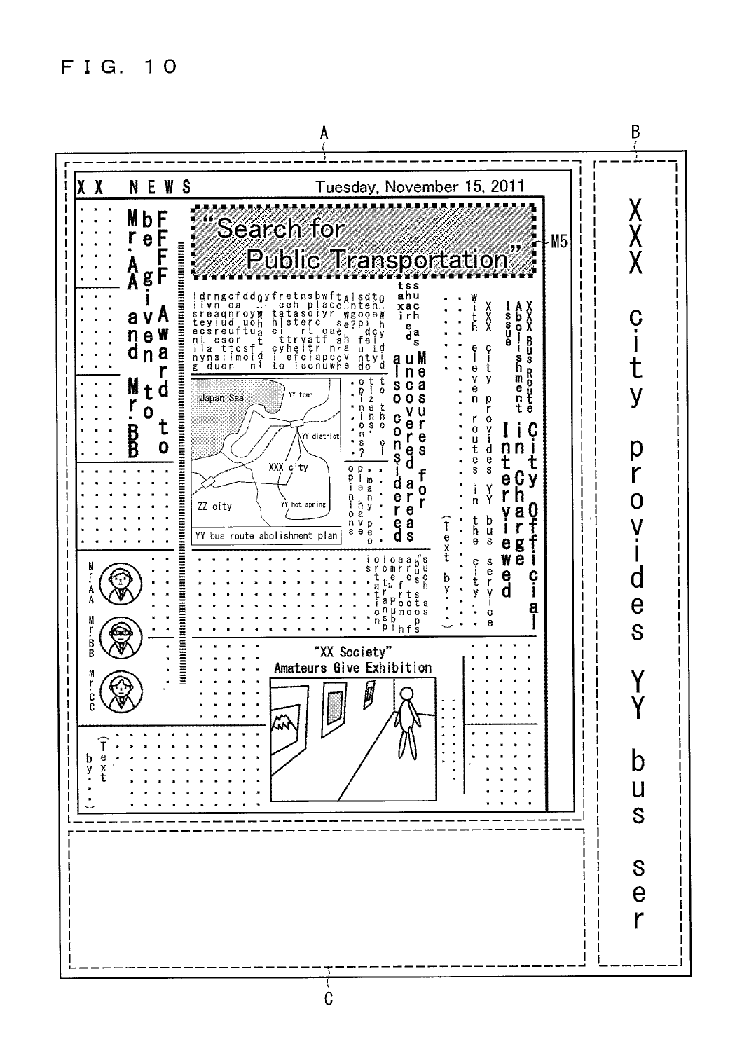

Next, the following discusses display of a mark on a headline of an article that is being displayed in an enlarged manner, with reference to FIG. 10. FIG. 10 is a view illustrating an example of a screen in which the headline is displayed with a mark.

As illustrated in FIG. 10, the page display area A has a mark M5 on the headline of the article of the document content displayed in the page display area A, while the article is being displayed in an enlarged manner. As described with reference to FIG. 5, it is possible to specify a position of the headline, with use of the headline list 33. Accordingly, with reference to the headline list 33, the mark M5 can be displayed on the headline.

Such display allows the user to easily recognize which article in the document content is being displayed in an enlarged manner.

[Flow of Process for Carrying Out Enlarged Display (Individual Display)]

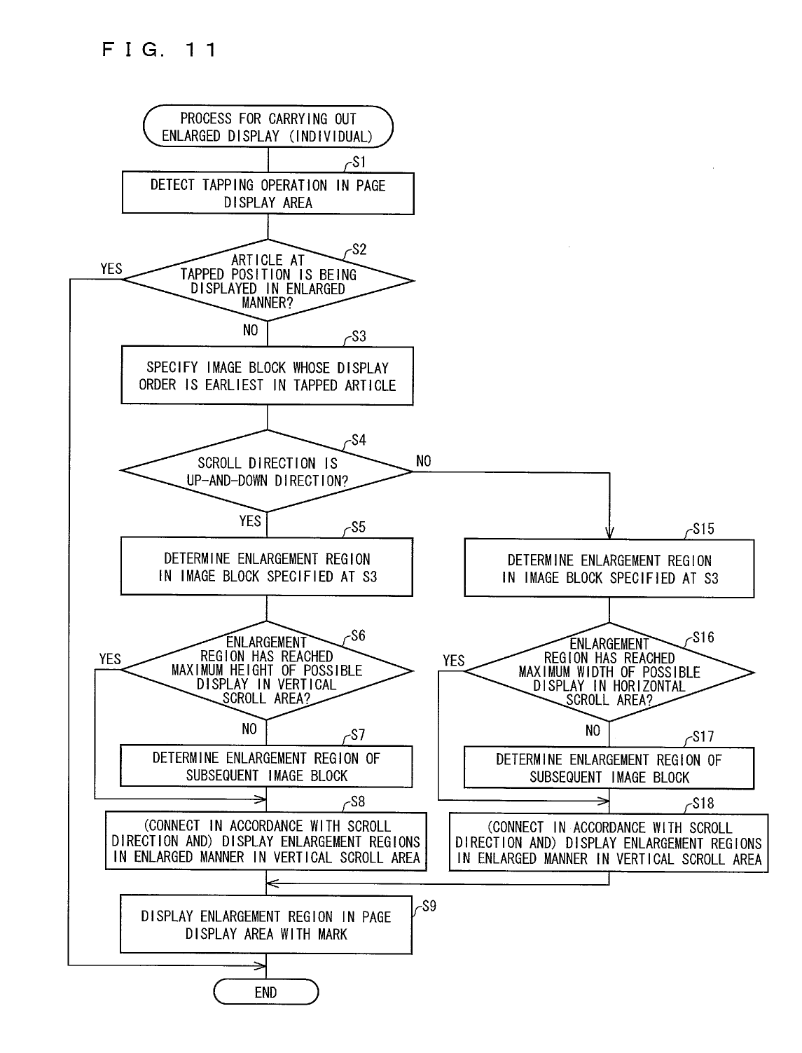

Next, the following will discuss, with reference to FIG. 11, a flow of a process for carrying out enlarged display at the time when the electronic book reader 1 carries out enlarged display. FIG. 11 is a flowchart showing an example of the process for carrying out enlarged display. In this example, enlarged display is carried out in either one of the vertical scroll area B and the horizontal scroll area C.

In a case where a user carries out a tapping operation in the page display area, information indicative of coordinates of a tapped position is transmitted from the input section 10 to the enlargement processing section 20. Then, the enlargement processing section 20 detects, on the basis of the coordinates, the tapping operation carried out in the page display area (S1).

The enlargement processing section 20 having detected the tapping operation determines whether or not an article at the tapped position is already being displayed in an enlarged manner (S2). More specifically, in a case where the enlarged display is already being carried out, the enlargement processing section 20 specifies an article ID of the article being displayed in an enlarged manner with reference to the article management information 30. Then, the enlargement processing section 20 compares the article ID specified, with an article ID of the article at the tapped position, and thereby determines whether or not the article at the tapped position is already being displayed in an enlarged manner.

At this step (S2), in a case where the enlargement processing section 20 determines that the article at the tapped position is already being displayed in an enlarged manner (Yes at S2), the enlargement processing section 20 terminates the process for carrying out enlarged display. Note that in this case, the enlargement region may be shifted so that the beginning of the enlargement region comes to the tapped position.

On the contrary, in a case where the enlargement processing section 20 determines that the article at the tapped position is not being displayed in an enlarged manner (NO at S3), the enlargement processing section 20 specifies, with reference to the article management information 30, an image block whose display order is the earliest from among image blocks of the article tapped (S3). More specifically, the enlargement processing section 20 specifies an image block having the smaller value of the display order from among the image blocks associated with an article ID identical to that of the article tapped, in the article management information 30.

Subsequently, the enlargement processing section 20 determines whether or not the scroll direction of the image block specified is the up-and-down direction (S4, scroll direction determining step, the step of determining a scroll direction). More specifically, the enlargement processing section 20 determines that the scroll direction is the up-and-down direction in a case where the scroll direction of the image block specified at S3 is UP or DOWN in the article management information 30. Meanwhile, the enlargement processing section 20 determines that the scroll direction is not the up-and-down direction in a case where the scroll direction of the image block specified at S3 is RIGHT or LEFT in the article management information 30.

At this step (S4), in a case where the enlargement processing section 20 determines that the scroll direction is the up-and-down direction (YES at S4), the enlargement processing section 20 determines an enlargement region in the image block specified at S3 (S5). Note that, because this image block is an image block to be scrolled in the up-and-down direction, the enlargement region is determined so that a height of the enlargement region is within a range in which enlarged display can be carried out in the vertical scroll area.

More specifically, first, the enlargement processing section 20 specifies the maximum height of a region to be enlarged which region can be displayed in the vertical scroll area. This maximum height is determined by the height of the vertical scroll area and an enlargement factor. For example, in a case where the height of the vertical scroll area is 980 dots and the enlargement factor is 2, the maximum height of the region to be enlarged becomes 490 dots.

Next, the enlargement processing section 20 specifies an enlargement region in the image block specified at S3, within a range of the above maximum height. For example, in the article management information 30 of FIG. 2, the image block whose display order is one (1) has the height of 363. Accordingly, in the case where the height of the vertical scroll area is 980 dots and the enlargement factor is 2, a whole of this image block becomes the enlargement region. On the other hand, in a case where the height of the vertical scroll area is 980 dots and the enlargement factor is 4, the maximum height is 245 dots. Accordingly, the enlargement region extends up to 245 dots from the top of this image.

Next, the enlargement processing section 20 determines whether or not the enlargement region determined at S5 has reached the maximum height of possible enlarged display in the vertical scroll area (S6). Here, in a case where the enlargement processing section 20 determines that the enlargement region has not reached the maximum height (NO at S6), the process for carrying out enlarged display proceeds to a process of S7. On the other hand, in a case where the enlargement processing section 20 determines that the enlargement region has reached the maximum height (YES at S6), the process of S7 is skipped and the process for carrying out enlarged display proceeds to a process of S8.

At S7, the enlargement processing section 20 determines an enlargement region of a subsequent image block. More specifically, the enlargement processing section 20 specifies an image block whose display order is the second smallest next to the image block specified at S3, in the article management information 30. Then, as to the image block specified, the enlargement processing section 20 determines an enlargement region so that a sum of the height of the image block specified at S7 and the height of the enlargement region having been determined at S5 becomes not more than the maximum height.

Note that the enlargement region determined at S7 is to be connected to the enlargement region determined at S5. Accordingly, the enlargement region is not determined at S7 unless the enlargement region determined at S7 is a region that can be connected to the enlargement region determined at S5. In other words, even in a state where there still are blank dots remaining within a range of the maximum height, the enlargement region is not determined at S7 when a group ID of the image block whose enlargement region has been determined and a group ID of a subsequent image group are different from each other.

At S8, the enlargement processing section 20 instructs the display processing section 21 to carry out, in the vertical scroll area, enlarged display of an image in the enlargement region determined as described above. Having received this instruction, the display processing section 21 reads out the image in the enlargement region determined and causes this image to be displayed in a manner enlarged at a predetermined enlargement factor in the vertical scroll area (enlarged display step, the step of causing a component to be displayed in an enlarged manner).

Note that in a case where the enlargement region extends over a plurality of image blocks (in a case where the enlargement region is determined at S7), an enlarged image of the enlargement region of the subsequent image block is displayed so as to be connected to an enlarged image of the preceding image block, at a position in accordance with the scroll direction of the enlarged image of the preceding image block.

More specifically, in a case where the scroll direction of the preceding image block (the image block specified at S3) is UP, the enlarged image of the enlargement region determined at S7 is displayed in the vertical scroll area so as to be connected to the bottom of the preceding image block. Similarly, in a case where the scroll direction of the preceding image block (the image block specified at S3) is DOWN, the enlarged image of the enlargement region determined at S7 is displayed in the vertical scroll area so as to be connected to the top of the preceding image block.

Note that, though the enlarged images may be connected and then displayed, the process for carrying out enlarged display may alternatively be arranged so that first, an image in which images prior to enlargement are connected is generated and then, the image including the connected images is enlarged and then displayed. In other words, in the process of S8, it is only necessary to display enlarged images of respective enlargement regions of two image blocks in a state where the enlarged images are connected in a predetermined display order in accordance with the scroll direction. For such display, a concrete process is not specifically limited.

In addition, the enlargement processing section 20 notifies the enlargement region determined, to the display processing section 21, and instructs the display processing section 21 to carry out display with a mark in the page display area. Having received such notification and instruction, the display processing section 21 carries out display with a mark so that an image of the notified enlargement region can be distinguished from other images (S9).

At S9, the enlargement processing section 20 may additionally notify whether the enlarged display has been carried out in the vertical scroll area or in the horizontal scroll area. Then, the display processing section 21 may display a mark in a different aspect (for example, in a different color) in accordance with the scroll area notified from the enlargement processing section 20. When the display with the mark is accomplished, the process for carrying out enlarged display is terminated.

Next, the following discusses a case where the image block specified at S3 is to be scrolled in the right-and-left direction. In such a case, the determination is NO at S4 and the process for carrying out enlarged display proceeds to a process of S15.

At S15, the enlargement processing section 20 determines an enlargement region in the image block specified at S3. Note that, because this image block is to be scrolled in the right-and-left direction, the enlargement region is determined so as to have a width in a range in which enlarged display can be carried out in the horizontal scroll area. A method of determining the enlargement region is the same as that at S5 and therefore, an explanation of the method is omitted here.

Next, the enlargement processing section 20 determines whether or not the enlargement region determined at S15 has reached the maximum width of possible enlarged display in the horizontal scroll area (S16). Here, in a case where the enlargement processing section 20 determines that the enlargement region has not reached the maximum height (NO at S16), the process for carrying out enlarged display proceeds to a process of S17. On the other hand, in a case where the enlargement processing section 20 determines that the enlargement region has reached the maximum height (YES at S16), the process of S17 is skipped and the process for carrying out enlarged display proceeds to a process of S18.

At S17, the enlargement processing section 20 determines an enlargement region of a subsequent image block. More specifically, the enlargement processing section 20 specifies an image block whose display order is the second smallest next to the image block specified at S3, in the article management information 30. Then, as to the image block specified, the enlargement processing section 20 determines an enlargement region so that a sum of the width of the image block specified at S17 and the width of the enlargement region having been determined at S15 becomes not more than the maximum width.

At S18, the enlargement processing section 20 instructs the display processing section 21 to carry out, in the horizontal scroll area, enlarged display of an image in the enlargement region determined as described above. Having received this instruction, the display processing section 21 reads out the image in the enlargement region determined and causes this image to be displayed in a manner enlarged at a predetermined enlargement factor in the horizontal scroll area (enlarged display step, the step of causing a component to be displayed in an enlarged manner).

Note that in a case where the enlargement region extends over a plurality of image blocks (in a case where the enlargement region is determined at S17), an enlarged image of the enlargement region of the subsequent image block is displayed so as to be connected to an enlarged image of the preceding image block at a position in accordance with the scroll direction of the enlarged image of the preceding image block.

More specifically, in a case where the scroll direction of the preceding image block (the image block specified at S3) is RIGHT, the enlarged image of the enlargement region determined at S17 is displayed in the horizontal scroll area so as to be connected to the left side of the preceding image block. Similarly, in a case where the scroll direction of the preceding image block (the image block specified at S3) is LEFT, the enlarged image of the enlargement region determined at S17 is displayed in the horizontal scroll area so as to be connected to the right side of the preceding image block. Subsequently, the process for carrying out enlarged display proceeds to a process of S9.

Note that, though two image blocks at the maximum are displayed in an enlarged manner in the example of FIG. 11, the number of image blocks to be connected may be three or more. In a case where three or more image blocks are displayed in an enlarged manner in the vertical scroll area, the process for carrying out enlarged display returns back to S6 after the process of S7, and repeats the processes of S6 and S7 until the determination becomes YES at S6. The same applies to the case where enlarged display is carried out in the horizontal scroll area.

[Flow of Process for Carrying Out Enlarged Display (Simultaneous Display)]

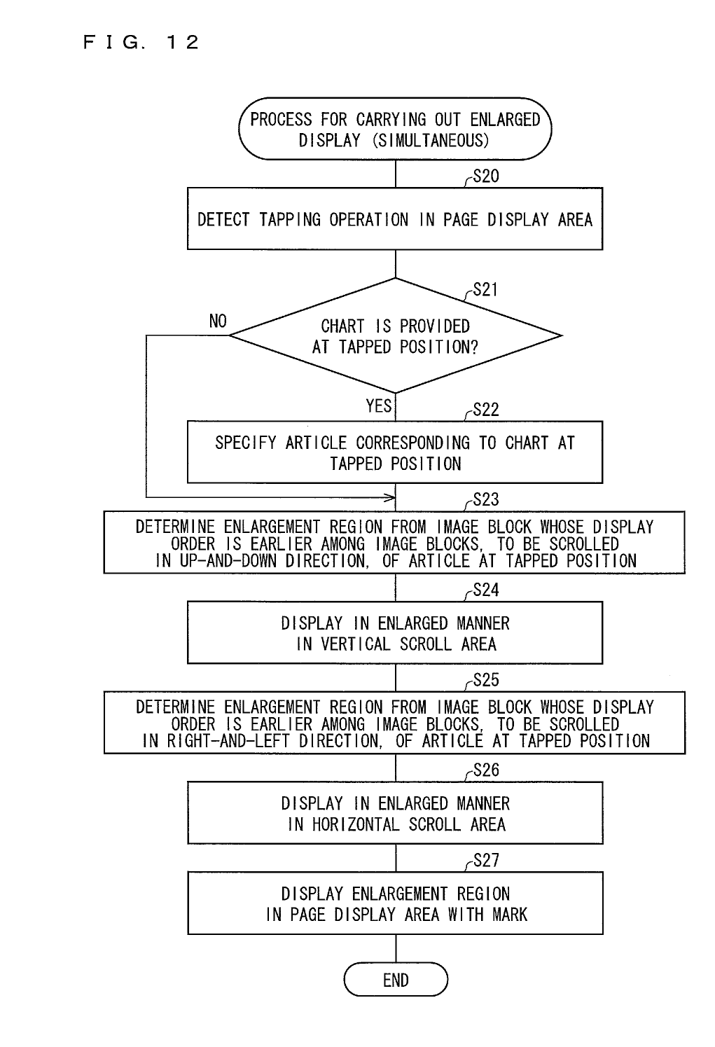

Next, the following will discuss, with reference to FIG. 12, another example of a process for carrying out enlarged display at the time when the electronic book reader 1 carries out enlarged display. FIG. 12 is a flowchart showing an example of the process for carrying out enlarged display. In this example, enlarged display is simultaneously carried out in both the vertical scroll area B and the horizontal scroll area C.

In a case where a user carries out a tapping operation in the page display area, information indicative of coordinates of a tapped position is transmitted from the input section 10 to the enlargement processing section 20. Then, the enlargement processing section 20 detects, on the basis of the coordinates, the tapping operation carried out in the page display area (S20).

The enlargement processing section 20 having detected the tapping operation determines whether or not the tapped position is a position where a chart (related chart) is provided (S21). More specifically, the enlargement processing section 20 determines, with reference to the related chart list 32, whether or not the tapped position is a position where a chart is provided. Here (at S21), in a case where the enlargement processing section 20 determines that the tapped position is a position where a chart is provided (YES at S21), the process for carrying out enlarged display proceeds to a process of S22. On the other hand, in a case where the enlargement processing section 20 determines that the tapped position is not a position where a chart is provided (NO at S21), the process for carrying out enlarged display proceeds to a process of S23.

At S22, the enlargement processing section 20 specifies, with reference to the related chart list 32, an article associated with the chart at the tapped position and then, proceeds to the process of S23. In other words, in the process for carrying out enlarged display as shown in FIG. 12, it is possible to display, with a tap on a chart, an article related to the chart in an enlarged manner. Note that selection of an article by such a tap on a chart can also be applied to the process for carrying out enlarged display as shown in FIG. 11.

At S23, the enlargement processing section 20 specifies, with reference to the article management information 30, image blocks to be scrolled in the up-and-down direction in the article at the tapped position (scroll direction determining step, the step of determining a scroll direction). Then, the enlargement processing section 20 determines an enlargement region from an image block that is to be displayed earlier according to the display order from among the image blocks specified. In this process, as in S5 to S7 of FIG. 11, the enlargement processing section 20 determines the enlargement region from one or more image blocks within a range in which enlarged display can be carried out in the vertical scroll area.

Note that as in the example of FIG. 11, in a case where the article at the tapped position is already being displayed, the process for carrying out enlarged display may be terminated without carrying out processes following S23 (not illustrated in FIG. 12). Further, in a case where the article at the tapped position is already being displayed in an enlarged manner, the main focus may be shifted to a scroll area associated with a tapped image block when the tapped image block corresponds to a scroll area where the main focus is not being displayed.

Then, the enlargement processing section 20 instructs the display processing section 21 so as to cause an image of the enlargement region determined at S23 to be displayed in an enlarged manner in the vertical scroll area (S24, enlarged display step, the step of causing a component to be displayed in an enlarged manner). Note that the process of S23 corresponds to the processes of S3, S5, S6, and S7 of FIG. 11, and a process of S24 corresponds to the process of S8 of FIG. 11.

Next, as in S23, the enlargement processing section 20 specifies image blocks to be scrolled in the right-and-left direction in the article at the tapped position (scroll direction determining step, the step of determining a scroll direction). Then, the enlargement processing section 20 determines an enlargement region from an image block to be displayed earlier according to the display order from among the image blocks specified (S25). Further, the enlargement processing section 20 causes an image of the enlargement region determined at S25 to be displayed in an enlarged manner in the horizontal scroll area (S26, enlarged display step, the step of causing a component to be displayed in an enlarged manner).

Furthermore, the enlargement processing section 20 notifies the enlargement region determined at S25 to the display processing section 21 and instructs the display processing section 21 to carry out display with a mark in the page display area. Having received such notification and instruction, the display processing section 21 carries out display of the image of the notified enlargement region with a mark in a manner distinguishable from other components of an image in layout display (S27).

At S27, the enlargement processing section 20 may additionally notify whether the enlarged display has been carried out in the vertical scroll area or in the horizontal scroll area. Then, the display processing section 21 may display a mark in a different aspect (for example, in a different color) in accordance with the scroll area notified from the enlargement processing section 20. When the display with the mark is accomplished, the process for carrying out enlarged display is terminated.

Further, at S27, the enlargement processing section 20 may cause the main focus to be displayed. The image block having the smallest value of the display order and a scroll area where this image block is displayed in an enlarged manner may be subjected to display with the main focus. Alternatively, the image block at the tapped position and a scroll area where this image block is displayed in an enlarged manner may be subjected to display with the main focus.

[Flow of Process for Carrying Out Related Chart Display]

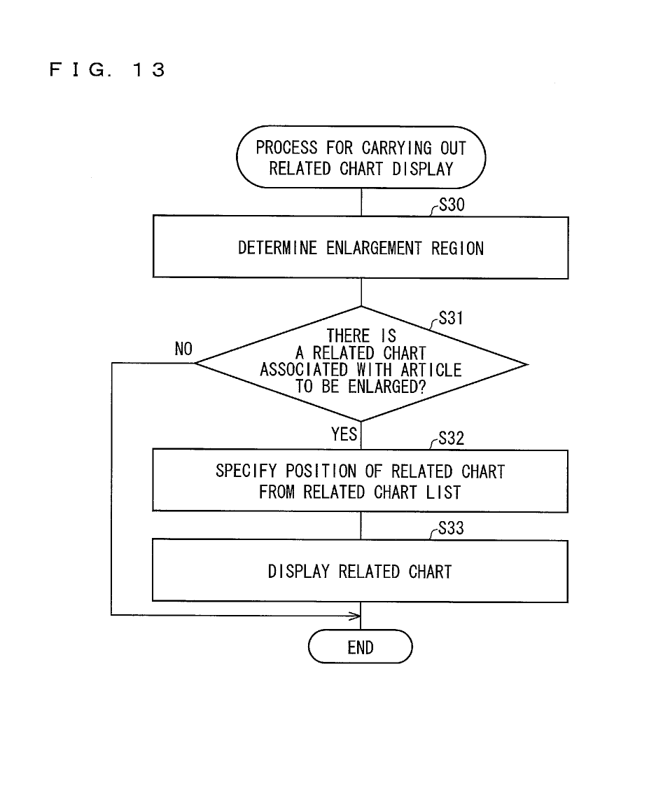

Then, the following discusses, with reference to FIG. 13, an example of a process for carrying out related chart display at the time when the electronic book reader 1 displays a related chart. FIG. 13 is a flow chart showing an example of the process for carrying out related chart display. The example described here is a case where the page display area A is set to display not the entire document content but a related chart while enlarged display is carried out. Needless to say, the process for carrying out related chart display may be arranged so that a related chart is displayed in the page display area A in response to a user operation or the like, by a shift from a state where the entire document content is displayed in the page display area A. In such a case, the process for carrying out related chart display starts with S31.

Having determined the enlargement region (S30), the enlargement processing section 20 notifies the related chart processing section 22 of an article ID of an article whose enlargement region is determined. Then, the related chart processing section 22 having received this notification determines whether or not there is a related chart associated with the article whose article ID has been notified (S31). More specifically, the related chart processing section 22 makes the above determination by finding out whether or not the article ID notified is included in the related chart list 32.

Here, in a case where the related chart processing section 22 determines that there is no related chart (NO at S31), the process for carrying out related chart display is terminated. Also, in a case where the image block having the article ID notified is being displayed in an enlarged manner, the process for carrying out related chart display may be terminated (not shown in FIG. 13). On the other hand, in a case where the related chart processing section 22 determines that there is a related chart (YES at S31), the related chart processing section 22 specifies a position of the related chart from the related chart list 32 (S32). Note that in a case where a plurality of related charts are present, respective positions of these related charts are specified.

Then, the related chart processing section 22 instructs the display processing section 21 so as to cause the related chart at the specified position to be displayed in the page display area (S33). Thereby, the process of carrying out related chart display is terminated. Note that the related chart is displayed preferably in an enlarged manner all over the page display area. Further, in a case where the respective positions of the plurality of related charts are specified at S32, these related charts may be displayed next to each other.

In the example of FIG. 13, the related chart is associated with the article ID. In a case where the related chart is associated with an image block as in the example of FIG. 4, the process for carrying out related chart display differs a little from that in the example of FIG. 13.

In other words, in a case where a related chart is associated with an image block, the enlargement processing section 20 having determined the enlargement region determines whether or not an image (image ID) is associated with an image block of the enlargement region, with reference to the article management information 30. In a case where the enlargement processing section 20 determines that the image is associated with an image block, the enlargement processing section 20 notifies the related chart processing section 22 of an image ID of the image block. Then, the related chart processing section 22 causes the related chart to be displayed, with reference to the related chart list 32.

Further, when enlarged display is to be carried out in both the vertical scroll area and the horizontal scroll area in a case where a related chart is associated with an image block, the enlargement processing section 20 should determine whether the image is associated with an image block that is displayed in an enlarged manner in a scroll area where the main focus is displayed.

[Flow of Process for Moving Enlargement Region]

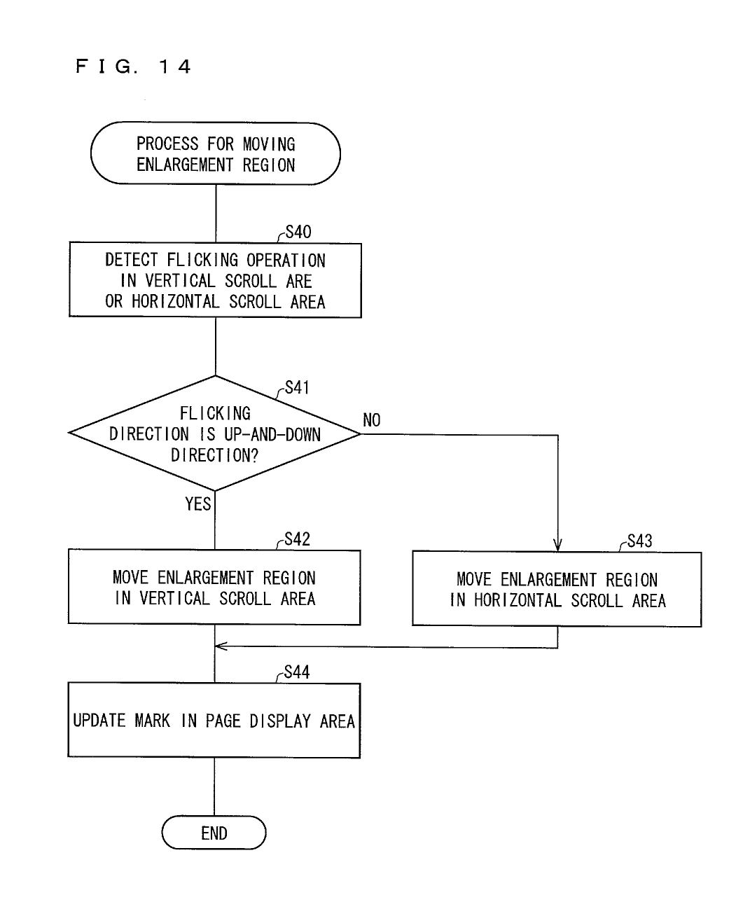

As described above, by making a flicking operation in the vertical scroll area or the horizontal scroll area, a position of the enlargement region can be moved. Here, the following discusses, with reference to FIG. 14, a flow of a process for moving a position of an enlargement region at the time when the position of the enlargement region is to be moved by a flicking operation. FIG. 14 is a flow chart showing one example of the process for moving the position of the enlargement region.

The enlargement processing section 20 detects the flicking operation in the vertical scroll area or in the horizontal scroll area, on the basis of the information transmitted from the input section 10 (S40) and then, determines whether or not a flicking direction is the up-and-down direction (S41).

Here (at S41), in a case where the enlargement processing section 20 determines that the flicking direction is the up-and-down direction (YES at S41), the enlargement processing section 20 moves a position of the enlargement region of the vertical scroll area (S42). More specifically, in a case of a downward flicking operation, the enlargement region is shifted upward so that the enlargement region moves back toward the beginning of the text. Further, in a case of an upward flicking operation, the enlargement region is shifted downward so that the enlargement region moves further toward the end of the text.

On the other hand, in a case where the enlargement processing section 20 determines that the flicking direction is not the up-and-down direction, in other words, the flickering direction is the right-and-left direction (NO at S41), the enlargement processing section 20 moves the position of the enlargement region of the horizontal scroll area (S43). More specifically, in a case of a leftward flicking operation, the enlargement region is shifted rightward so that the enlargement region moves back toward the beginning of the text. Further, in a case of a rightward flicking operation, the enlargement region is shifted leftward so that the enlargement region moves further toward the end of the text.

The enlargement processing section 20 moves the position of the enlargement region as described above. Then, the enlargement processing section 20 notifies the display processing section 21 of thus moved enlargement region so that the enlarged display is updated. Further, similarly, the enlargement processing section 20 causes the display processing section 21 to update a mark in the page display area (S44). Thereby, the process for moving the position of the enlargement region is terminated.

Note that in a case where the position of the enlargement region is moved from the end or the beginning of a current image block, an object to be enlarged becomes a subsequent or preceding image block that has an immediately following or preceding display order and that has the same group ID as the current image block. For example, when the position of the enlargement region is moved upward from a state where the end of the current image block is the enlargement region, enlarged display is carried out so that the end of the current image block is followed by a top of a subsequent image block that has an immediately following display order and that has the same group ID as the current image block.

Meanwhile, when the position of the enlargement region is moved from the end of the last image block or the beginning of the first image block of one group ID, a transition to an image block having another group ID or a transition to another article is carried out. This will be discussed later when an article transition process is described.

[Flow of Scroll Process]

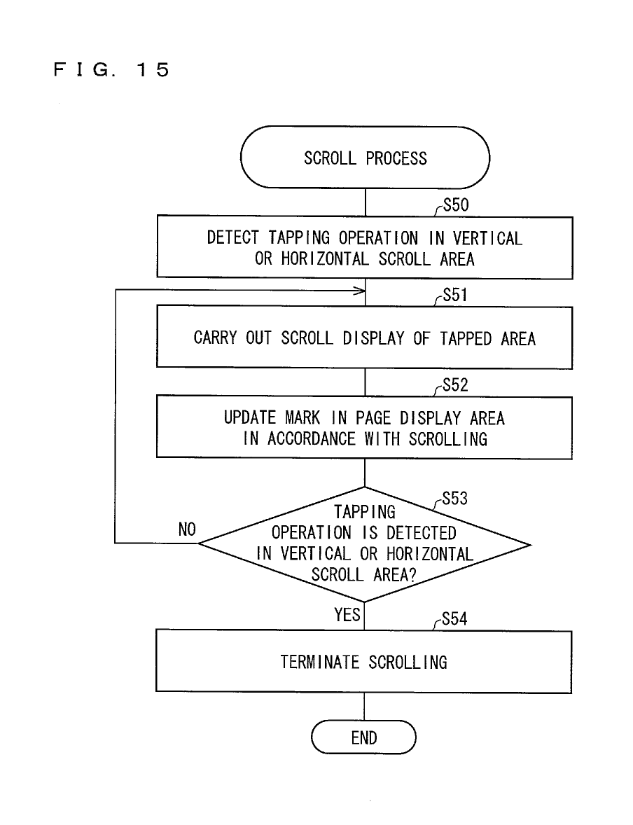

As described above, it is possible to automatically scroll the enlargement region by a tapping operation in the vertical scroll area or the horizontal scroll area. The following discusses, with reference to FIG. 15, a flow of a scroll process in which the enlargement region is automatically scrolled. FIG. 15 is a flowchart showing an example of the scroll process.

The enlargement processing section 20 detects the tapping operation made in the vertical scroll area or the horizontal scroll area, on the basis of the information transmitted from the input section 10 (S50), and causes scrolling display of a tapped area to be carried out (S51). Further, in accordance with scrolling, a mark in the page display area is updated (S52).

More specifically, the enlargement processing section 20 causes the position of the enlargement region in a tapped scroll area to move toward the end of the text at a predetermined constant speed. Further, the enlargement processing section 20 instructs the display processing section 21 to update enlarged display in accordance with such movement of the enlargement region. Furthermore, the enlargement processing section 20 instructs the display processing section 21 to update a mark in the page display area.

Note that it is desirable to change a scroll speed depending on whether a scroll area to be scrolled is the vertical scroll area or the horizontal scroll area. For example, in the example of FIG. 8, the number of letters in the horizontal scroll area is larger than the number of letters in the vertical scroll area. In such a case, a scroll speed of one area may be too slow or too fast if the scroll speed is arranged to be the same in both the horizontal scroll area and the vertical scroll area. Therefore, it is desirable to independently set the scroll speed of each scroll area at a speed that is adequate for a user to read the text displayed in the area.

When the enlargement processing section 20 detects, during the scrolling display, a tapping operation made in the vertical scroll area or the horizontal scroll area, on the basis of the information transmitted from the input section 10 (YES at S53), the enlargement processing section 20 stops the scrolling (S54) and terminates the scrolling process.

Note that in a case where the enlargement region is moved from the end of a current image block, an image block to be enlarged becomes a subsequent image that has the same group ID as the current image block and that has the immediately following display order.

On the other hand, in a case where the position of the enlargement region is moved from the end of the last image block of one group ID, a transition to an image block having another group ID or a transition to another article is carried out. This will be discussed later when an article transition process is described.

[Flow of Article Transition Process]

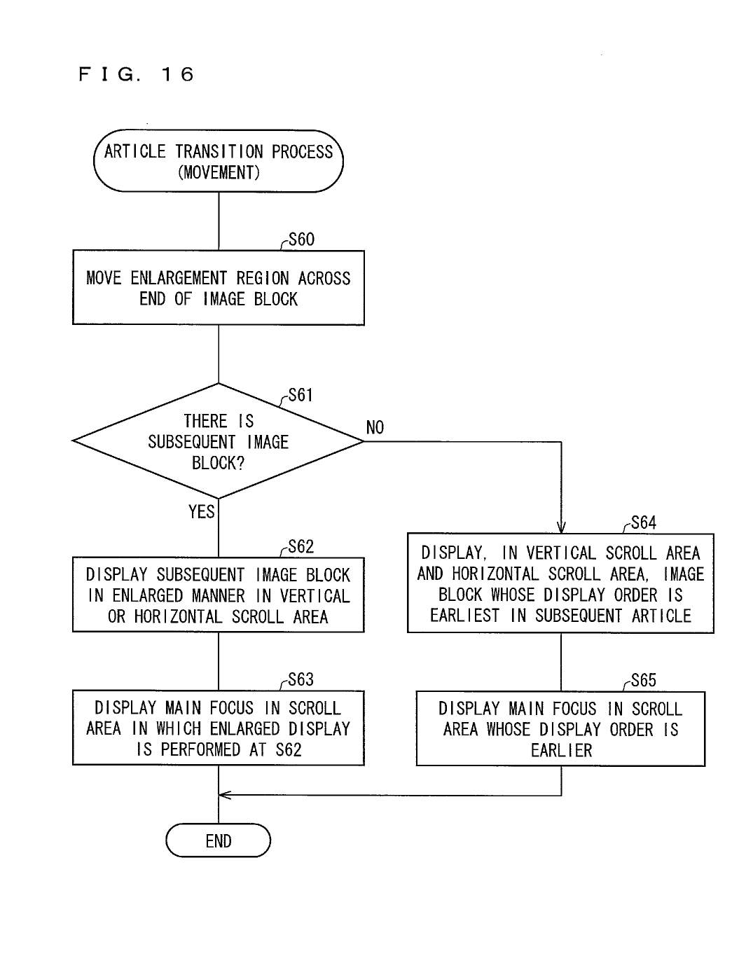

Next, the following discusses, with reference to FIG. 16, a flow of an article transition process in which the position of the enlargement region is moved so as to make a transition of the image block to be enlarged to an image block having another group ID or to an image block of another article. FIG. 16 is a flowchart showing an example of the article transition process. Note that the following description will deal with a process in an example case in which display is carried out simultaneously in both the vertical scroll area and the horizontal scroll area.

In a case where the position of the enlargement region is moved across the end of an image block (S60), the enlargement processing section 20 determines whether or not there is a subsequent image block (S61). Note that the case in which the position of the enlargement region is moved across the end of an image block means, for example, a case in which, by making a flicking operation or automatic scrolling, the enlargement region is made to advance further in the document content (move toward the end of the text) from a state where the end of the image block is included in the enlargement region.

Also note that the subsequent image block means an image block that is associated with an article ID identical to that of an image block of a current enlargement region but has a group ID different from that of the image block of the current enlargement region, and has a display order immediately following that of the image block of the current enlargement region. That is, a case in which there is no subsequent image block means a case in which the display order of the image block of the current enlargement region is the last (the value of the display order is the greatest) among the display orders of image blocks having an article ID identical to that of the image block of the current enlargement region.

In this step (S61), in a case where the enlargement processing section 20 determines that there is a subsequent image block (YES at S61), the enlargement processing section 20 causes the subsequent image block to be displayed in an enlarged manner in the vertical scroll area or the horizontal scroll area, depending on the scroll direction of the image block of the enlargement region (S62). More specifically, the enlargement processing section 20 causes the subsequent image block to be displayed in an enlarged manner in the vertical scroll area in a case where the scroll direction of the subsequent image block is UP or DOWN, or in the horizontal scroll area in a case where the scroll direction of the subsequent image block is RIGHT or LEFT.

Subsequently, the enlargement processing section 20 instructs the display processing section 21 so as to cause the main focus to be displayed in the scroll area in which the enlarged display was carried out at S62 (S63). This allows the user to easily recognize in which scroll area the article with the subsequent display order is being displayed in an enlarged manner. After the main focus is displayed, the article transition process is terminated.

In this way, making a transition of the image block to be enlarged to an image block with a different group ID allows going on to read details of an article, by a flicking operation or a tapping operation, after reading a summary of the article. Note that in this case, display order values may be set so that a group corresponding to details of an article immediately follows a group corresponding to a summary of the article.

On the other hand, at S61, in a case where the enlargement processing section 20 determines that there is no subsequent image block (NO at S61), the enlargement processing section 20 causes image blocks, a display order of each of which is the earliest among image blocks of the subsequent article, to be displayed in an enlarged manner in the vertical scroll area and the horizontal scroll area, respectively (S64).

More specifically, the enlargement processing section 20 specifies, with reference to the article management information 30, an article ID whose value is the second smallest next to the article ID of the article being displayed in an enlarged manner. Next, the enlargement processing section 20 specifies an image block having the smallest display order value among image blocks which are associated with the specified article ID and whose scroll directions are UP or DOWN. The enlargement processing section 20 also specifies an image block having the smallest display order value among image blocks which are associated with the specified article ID and whose scroll directions are RIGHT or LEFT. Then, the enlargement processing section 20 causes each of the specified image blocks to be displayed, from the beginning thereof, in an enlarged manner in corresponding one of the vertical scroll area and the horizontal scroll area.

Next, the enlargement processing section 20 instructs the display processing section 21 so as to cause the main focus to be displayed in a scroll area which is one of the vertical scroll area and the horizontal scroll area and has a display order earlier than that of the other (S65), and terminates the article transition process.

Note that an article transition process carried out in a case where enlarged display is carried out only in one of the vertical scroll area and the horizontal scroll area is similar to that carried out in the example of FIG. 16. Note, however, that in the case where enlarged display is carried out only in one of the vertical scroll area and the horizontal scroll area, enlarged display at S62 is carried out in such a manner that what is displayed in an enlarged manner in the other of the vertical scroll area and the horizontal scroll area is cleared (deleted), if any, so that the enlarged display is carried out only in the one of the vertical scroll area and the horizontal scroll area. Further, at S64, only the image block having the smallest display order value is displayed in an enlarged manner in the vertical scroll area or the horizontal scroll area. It is not necessary to carry out the processes of S63 and S65.

Furthermore, although a transition from a current article to a subsequent article in the above-described example is made from an image block whose display order is the last in the current article, the transition may alternatively be made from the middle of the current article to the subsequent article. For example, the transition to the subsequent article may be made from an image block that is in the end of a group corresponding to a summary of the current article. This allows quickly viewing only summaries of the respective articles. Note that whether or not an image block corresponds to a summary of an article or details of the article can be determined by a group ID of the image block.

[Flow of Article Transition Process by Tapping Operation]

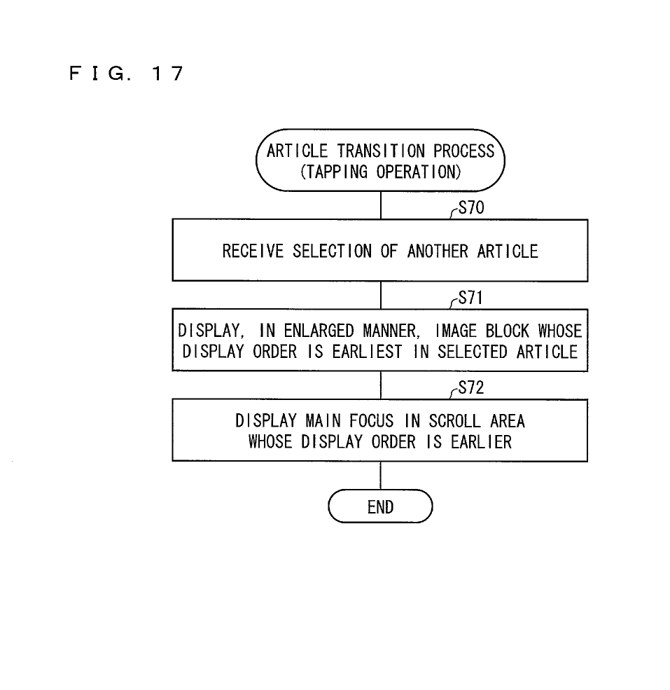

Next, the following discusses, with reference to FIG. 17, a flow of an article transition process in which a transition of a subject to be enlarged to another article is made by a tapping operation. FIG. 17 is a flowchart showing an example of the article transition process in which the transition of the subject to be enlarged to another article is made by the tapping operation.

In a case where the enlargement processing section 20 receives a selection of another article by a tapping operation (S70), the enlargement processing section 20 causes an image block, a display order of which is the earliest in the selected article, to be displayed in an enlarged manner (S71). Then, the enlargement processing section 20 instructs the display processing section 21 to cause the main focus to be displayed in a scroll area which is one of the vertical scroll area and the horizontal scroll area and has a display order earlier than that of the other (S72), and terminates the article transition process.

Note that, receiving a selection of another article by a tapping operation means detecting a tapping operation of an image block or a related chart having an article ID different from that of an article which is currently displayed in an enlarged manner. Also note the processes of S71 and S72 are similar to the processes of S64 and S65 of FIG. 16, respectively, and descriptions on the processes of S71 and S72 are omitted.

[Flow of Headline Marking Process]

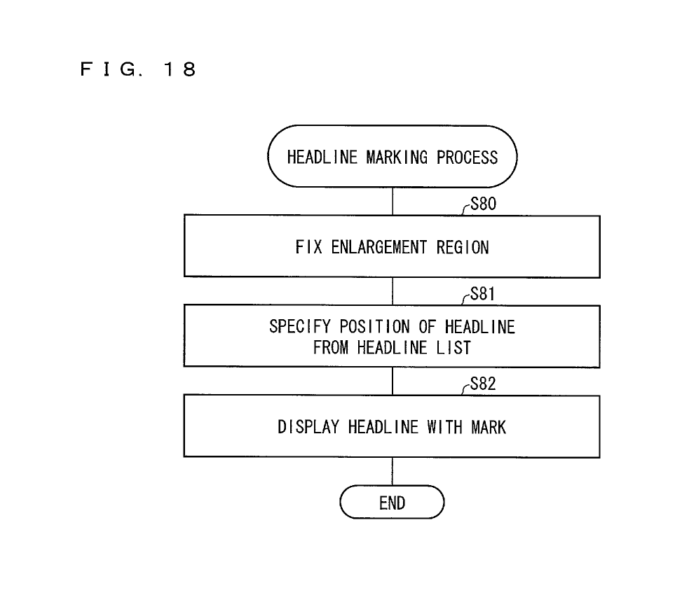

Next, the following discusses, with reference to FIG. 18, a flow of a headline marking process in which a headline of an article being displayed in an enlarged manner is displayed with a mark. FIG. 18 is a flowchart showing an example of the headline marking process.

When the enlargement processing section 20 fixes an enlargement region (S80), the enlargement processing section 20 notifies, to the headline processing section 23, an article ID of an article in which the enlargement region has been fixed. Then, the headline processing section 23 having received the notification specifies, with reference to the headline list 33, a position of a headline of the article having the notified article ID (S81).

Then, the headline processing section 23 instructs the display processing section 21 so as to cause a headline at the specified position to be displayed with a mark (S82). Thereby, the headline marking process is terminated. Note that marking of a headline is not limited to a specific aspect, provided that it allows the user to recognize the headline. For example, an image process may be carried out so as to apply a translucent color throughout the region of the headline.

[Display of Text-Based Document Content]

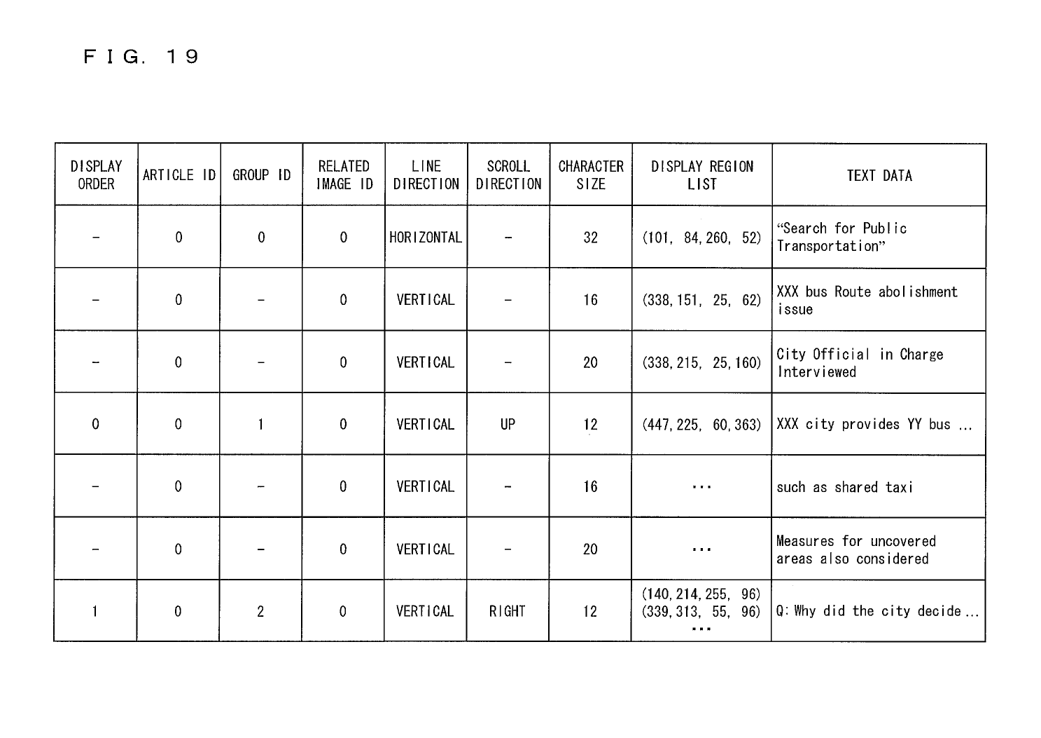

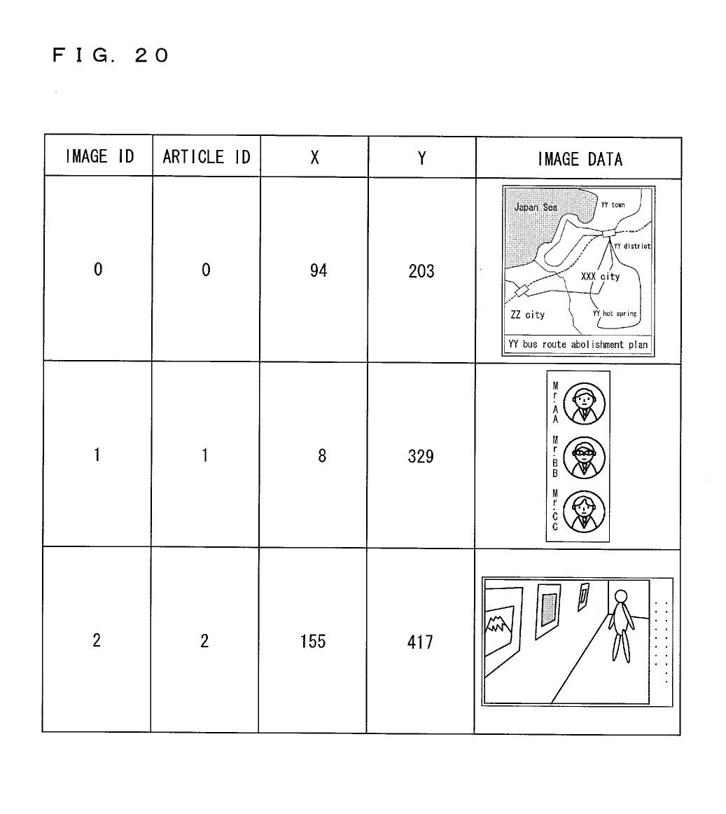

The descriptions above have discussed an example in which page layout-type document content (image-based document content). Note, however, that the document content to be displayed may be text-based document content (e.g., reflow-type document content). The following description will discuss, with reference to FIGS. 19 and 20, an example in which the subject to be displayed is text-based document content.

[Data Structure]

A data structure for displaying text-based document content can be, for example, a data structure illustrated in FIG. 19. FIG. 19 is a view illustrating an example of text layout information for displaying text-based document content.

The text layout information illustrated in FIG. 19 is data in a table format in which nine elements of (i) display order (display order information), (ii) article ID (article identification information), (iii) group ID (summary identification information), (iv) related image ID, (v) line direction, (vi) scroll direction (scroll information), (vii) character size, (viii) display region list, and (ix) text data are associated with each set of texts (hereinafter referred to as text block) constituting document content. That is, components of document content in the above-described example are image blocks, whereas components of document content in this example are text blocks. Note that the format of the text layout information is not limited to the table format.

The display order indicates the display order of texts at the time when the texts are displayed in an enlarged manner. A text having a smaller display order value is displayed earlier. In the example illustrated in FIG. 19, a value “0” is associated with a text block having the earliest display order. Note that as indicated with “-” in FIG. 19, no display order value is associated with a text block that is not to be displayed in an enlarged manner.

The article ID is identification information for identifying an article to which a text block belongs. Text blocks belonging to the same article are given an identical article ID. The group ID is identification information assigned to a component of an article such as headline, summary, or details. The related image ID is identification information that indicates an image (related chart etc.) related to a text block.

The line direction indicates a direction in which letters included in a text block is read. That is, the line direction is information that indicates whether the letters included in the text block are to be written vertically or horizontally. The scroll direction indicates a scroll direction in which the text block including the letters is scrolled at the time when the text is displayed in an enlarged manner. As such, no scroll direction information is associated with a text block that is not to be displayed in an enlarged manner. The character size indicates a size (e.g., font size) in which letters included in a text block are displayed.

The display region list indicates a region in which letters included in a text block is displayed on the screen. In the example illustrated in FIG. 19, the display region is represented in the form of (an X coordinate of the display region, a Y coordinate of the display region, a width of the display region, and a height of the display region). As in the case of a text block whose display order is 1 in the example illustrated in FIG. 19, a text block can be associated with a plurality of display regions. The text data indicates letters included in a text block.

A data structure for displaying an image (related chart etc.) included in document content can be, for example, a data structure illustrated in FIG. 20. FIG. 20 is a view illustrating an example of image layout information (associated-image information) for displaying an image together with a text displayed on the basis of the text layout information of FIG. 19.

The image layout information illustrated in FIG. 20 is data in a table format in which five elements of (i) image ID, (ii) article ID, (iii) X, (iv) Y, and (v) image data are associated with each image. Needless to say, the format of the image layout information is not limited to the table format.

The image ID is identification information which is assigned to each image in order to identify the each image. The article ID is identification information for identifying an article to which an image belongs, and is identical to the article ID of the text layout information.

X and Y indicate a position in which an image is displayed on the screen. More specifically, X and Y indicate an X coordinate and a Y coordinate of an upper left apex of the image. The image data is actual data of an image.

[Display of Document Content]

By using the text layout information and the image layout information as described above, it becomes possible to display a page screen as illustrated in FIG. 2 etc. The following description will discuss a process of displaying a page screen by use of the text layout information illustrated in FIG. 19 and the image layout information illustrated in FIG. 20. Note that this process is carried out by the display processing section 21.

First, the display processing section 21 causes text data included in the text layout information to be displayed in corresponding one of the regions indicated by the display region list. At this time, in a case where more than one corresponding region is included in the display region list, the display processing section 21 causes the text data to be displayed first in a preceding region up to the end thereof, and then causes a subsequent part of the text data to be displayed in a subsequent region.

Note that text data is displayed in accordance with the line direction and the character size. That is, each letter included in the text data is displayed in a size indicated by the character size. In a case where the line direction is vertical, the letters are displayed from top to bottom, and when the lower end of the display region is reached, subsequent letters are displayed from the upper end of a subsequent line located to the immediate left of a preceding line. Similarly, in a case where the line direction is horizontal, the letters are displayed from left to right, and when the right end of the display region is reached, subsequent letters are displayed from the left end of a subsequent line.

By carrying out this process with respect to all the text blocks, layout display of the text is completed.

Further, the display processing section 21 carries out, with respect to all images, a process of displaying image data in a position specified by an X value and a Y value, with reference to the image layout information. This causes a page screen including the text and the images to be displayed.

[Process for Carrying Out Enlarged Display]

Next, the following will discuss a process for carrying out enlarged display with use of the text layout information and the image layout information as described above.

In a case where the text layout information and the image layout information are used, the enlargement processing section 20 detects a tapping operation made in a region indicated by the display region list, but does not detect a tapping operation made in other regions. Further, even in a case where the enlargement processing section 20 detects a taping operation made in a region indicated by the display region list, the enlargement processing section 20 terminates the process, without carrying out enlarged display, unless a scroll direction is associated with the region.

In a case where an article is selected by a tapping operation, the enlargement processing section 20 determines, with reference to the text layout information, a scroll direction of a corresponding text block (scroll direction determination step, the step of determining a scroll direction of a component to be displayed in an enlarged manner).

Then, in a case where the scroll direction of the text block is UP or DOWN, the enlargement processing section 20 causes the text block to be displayed in an enlarged manner in the vertical scroll area, and in a case where the scroll direction of the text block is RIGHT or LEFT, the enlargement processing section 20 causes the text block to be displayed in an enlarged manner in the horizontal scroll area (enlarged display step, the step of causing a component to be displayed in an enlarged manner). At this time, since the text data is used for the enlarged display, the process is carried out by use of any one of the following four methods, depending on the line direction and the scroll direction.

(1) In a case where the line direction is vertical and the scroll direction is LEFT or RIGHT (e.g., a case where vertically written document content is displayed in multiple columns), the letters are vertically displayed in an enlarged manner from an upper right of the horizontal scroll area. Then, when the lower end of the horizontal scroll area is reached, subsequent letters are displayed in an enlarged manner from the upper end of a subsequent line (a line to the immediate left of the current line).

(2) In a case where the line direction is vertical and the scroll direction is UP or DOWN, the letters are displayed vertically in an enlarged manner from the upper end of the vertical scroll area. In this case, letters are displayed in a single line in the vertical scroll area.

(3) In a case where the line direction is horizontal and the scroll direction is LEFT or RIGHT, the letters are horizontally displayed in an enlarged manner from the left end of the horizontal scroll area. In this case, letters are displayed in a single line in the horizontal scroll area.

(4) In a case where the line direction is horizontal and the scroll direction is UP or DOWN (e.g., a case in which horizontally written document content is displayed in multiple columns), the letters are horizontally displayed in an enlarged manner from an upper left of the vertical scroll area. Then, when the right end of the vertical scroll area is reached, subsequent letters are displayed in an enlarged manner from the left end of a subsequent line (a line below the current line).

Note that in the case where the document content is displayed in multiple columns, the size of the letters displayed in the vertical scroll area or the horizontal scroll area may be adjusted so as to be in conformity with the layout of the page display area. That is, the letters may be displayed in an enlarged manner in a size that allows a line feed position of the document content in the page display area to coincide with a line feed position of the document content at the time when the document content is displayed in an enlarged manner.

In a case where the document content is displayed in an enlarged manner in a single line in the vertical scroll area, the document content may be displayed in an enlarged manner with a maximum character size that allows the letters to fit in the width of the vertical scroll area. Similarly, in a case where the document content is displayed in an enlarged manner in a single line in the horizontal scroll area, the document content may be displayed in an enlarged manner with a maximum character size that allows the letters to fit in the height of the horizontal scroll area.

[Display of Related Chart]

Also in a case where the text layout information and the image layout information are used, it is possible to display a related chart by a similar process as in the case shown in FIG. 13.

In a case where the enlargement processing section 20 fixes, by use of the text layout information, a text block to be enlarged, the enlargement processing section 20 notifies, to the related image processing section 22, an article ID that is associated with the text block whose enlargement region has been fixed. Then, the related image processing section 22 acquires, from the image layout information, image data of an image with which the notified article ID is associated, and displays the image data in an enlarged manner in the page display area. Note that in a case where a plurality of images are associated with one article ID in the image layout information, the associated plurality of images may be displayed side by side.

Also note that by using the related image ID included in the text layout information illustrated in FIG. 19, it is possible to display associated images on a text block-by-text block basis.

In this case, when the enlargement processing section 20 fixes an enlargement region by use of the text layout information, the enlargement processing section 20 notifies, to the related image processing section 22, a related image ID of a text block whose enlargement region has been fixed. Then, the related image processing section 22 acquires, from the image layout information, image data of an image with which the notified related image ID is associated, and causes the image data to be displayed in an enlarged manner in the page display area.

[Transition of Article to be Displayed in Enlarged Manner]

Next, the following discusses a process in which a transition of an article to be displayed in an enlarged manner is made by using the text layout information.

In a case where any of the text blocks that are registered in the text layout information and are being displayed is selected by a tapping operation or the like, the enlargement processing section 20 determines whether or not a text having an article ID of the selected text block is being displayed in an enlarged manner. This can be determined according to whether or not article IDs coincide with each other. In a case where the enlargement processing section 20 determines that the text having the article ID of the selected text block is being displayed in an enlarged manner, the enlargement processing section 20 terminates the process without making a transition of the article to be displayed in an enlarged manner.

On the other hand, in a case where the enlargement processing section 20 determines that the text having the article ID of the selected text block is not being displayed in an enlarged manner, the enlargement processing section 20 specifies a text block that has the smallest display order value among all the text blocks with which the article ID of the selected text block is associated. Then, the enlargement processing section 20 causes text data of the specified text block to be displayed in an enlarged manner in the vertical scroll area or the horizontal scroll area.

Note that in a case where the enlarged display is carried out both in the vertical scroll area and the horizontal scroll area, the enlargement processing section 20 specifies a text block having the smallest display order value from among each of (i) text blocks whose scroll directions are RIGHT or LEFT and (ii) text blocks whose scroll directions are UP or DOWN. Then, the enlargement processing section 20 causes text data of these specified text blocks to be displayed in an enlarged manner in the vertical scroll area and the horizontal scroll area, respectively.

[Transition of Article by Selecting Image]

Next, the following discusses a process in which, when an image (a related chart etc.) being displayed is selected, a transition of an article to be displayed in an enlarged manner is made by use of the text layout information and the image layout information.

When the enlargement processing section 20 determines, on the basis of the image layout information, that an image is being displayed in a position tapped by the user, the enlargement processing section 20 specifies an article ID that is associated with the image in the image layout information. Note that in a case where the specified article ID coincides with an article ID of a text which is currently displayed in an enlarged manner, the enlargement processing section 20 terminates the process at this stage.

Then, the enlargement processing section 20 causes text data to be displayed in an enlarged manner in the vertical scroll area or the horizontal scroll area which text data belongs to a text block that has the smallest display order value among all the text blocks with which the specified article ID is associated.

Note that in a case where the enlarged display is carried out both in the vertical scroll area and the horizontal scroll area, the enlargement processing section 20 specifies a text block having the smallest display order value from among each of (i) text blocks whose scroll directions are RIGHT or LEFT and (ii) text blocks whose scroll directions are UP or DOWN. Then, the enlargement processing section 20 causes text data of these specified text blocks to be displayed in an enlarged manner in the vertical scroll area and the horizontal scroll area, respectively.

[Headline Marking Process]

Next, the following discusses a process in which a headline of an article is displayed with a mark by use of the text layout information.

When the enlargement processing section 20 fixes, by use of the text layout information, a text block to be enlarged, the enlargement processing section 20 notifies, to the headline processing section 23, an article ID that is associated with the text block whose enlargement region has been fixed.

Next, the headline processing section 23 specifies a text block having a group ID of 0 among text blocks with which the notified article ID is associated. That is, a group ID of a text block of a headline is preset to 0.

Then, the headline processing section 23 specifies, by use of the display region list, a display region of the specified text block, and causes the text block to be displayed in the specified display region with a mark.

Note that the headline marking process may be carried out in a state where enlargement display is not being carried out. For example, the headline marking process may be carried out during the process described in the section [Display of Document Content] above. In this case, a mark is displayed on all the headlines (all the text blocks having a group ID of 0). This allows the user to recognize easily what article is included in document content.

The present invention is not limited to the above-described embodiments but allows various modifications within the scope of the claims. In other words, any embodiment derived from a combination of two or more technical means appropriately modified within the scope of the claims will also be included in the technical scope of the present invention.

[Configuration Example Realized by Software]

Lastly, each block of the electronic book reader 1, especially the control section 12, can be (i) realized by means of hardware by use of logic circuits provided on an integrated circuit (IC chip) or (ii) realized by means of software by use of a CPU (Central Processing Unit).

In the latter case, the electronic book reader 1 includes a CPU for executing commands of a program for implementing each function, a ROM (Read Only Memory) in which the program is stored, a RAM (Random Access Memory) on which the program is loaded, a storage device (recording medium), such as a memory, in which the program and various data are stored, and the like. An object of the present invention can be attained by the following procedures (i) and (ii): (i) loading, to the electronic book reader 1, the recording medium, in which program code (an executable program, an intermediate code program, and a source program) of the control program (software for implementing the functions) of the electronic book reader 1 is recorded so as to be read out by a computer and (ii) causing the computer (or a CPU or an MPU) to read out and execute the program code recorded in the recording medium.

For example, a tape such as a magnetic tape or a cassette tape, a disk including (i) a magnetic disk such as a floppy (Registered Trademark) disk or a hard disk and (ii) an optical disc such as a CD-ROM, an MO, an MD, a DVD, or a CD-R, a card such as an IC card (including a memory card) or an optical card, a semiconductor memory such as a mask ROM, an EPROM, an EEPROM (Registered Trademark), or a flash ROM, a logic circuit such as a PLD (Programmable Logic Device) or an FPGA (Field Programmable Gate Array), or the like can be used as the recording medium.

Further note that the electronic book reader 1 can be configured so as to be capable of being connected to a communications network via which the program code is loaded to the electronic book reader 1. The communications network is not limited to a specific one as long as the communications network can transfer the program code. The communications network can be, for example, an internet, an intranet, an extranet, a LAN, an ISDN, a VAN, a CATV communications network, a virtual private network, a telephone network, a mobile telecommunications network, a satellite communication network or the like. A transmission medium that constitutes the communications network is not limited to a specific one as long as the transmission medium is a medium that can transfer the program code. The examples of the transmission medium encompass (i) wired communications such as IEEE1394, USB, a power-line carrier, a CATV line, a telephone line, or ADSL (Asymmetric Digital Subscriber Line) and (ii) wireless communications such as infrared communication by means of IrDA or remote control, Bluetooth (Registered Trademark), IEEE802.11 wireless, HDR (High Data Rate), NFC (Near Field Communication), DLNA (Digital Living Network Alliance), a mobile phone network, a satellite circuit, or a terrestrial digital network. Note that the present invention can be realized also by means of a computer data signal embedded in a carrier wave, which computer data signal is obtained by embodying the program code in electronic transmission.

[Points of the Invention]

As described above, a display control device of the present invention includes: scroll direction determining means for determining, with reference to scroll information, a scroll direction of a component to be displayed in an enlarged manner, the scroll information being indicative of a scroll direction in which each of the plurality of components is scrolled when displayed in an enlarged manner; and enlargement processing means for causing the component, which is to be displayed in an enlarged manner, to be displayed in an enlarged manner in an enlarged-display area in which scrolling in the scroll direction determined by the scroll direction determining means is possible, among one or a plurality of enlarged-display areas which are different from a layout display area in which layout display of the plurality of components is performed.

The display control device preferably has a configuration in which, in a case where the scroll direction determining means determines that the scroll direction of the component to be displayed in an enlarged manner is a vertical direction, the enlargement processing means causes the component to be displayed in an enlarged manner in an enlarged-display area which is located on the right or left side of the layout display area and in which scrolling display in the vertical direction is possible, among the plurality of enlarged-display areas, and in a case where the scroll direction determining means determines that the scroll direction of the component to be displayed in an enlarged manner is a horizontal direction, the enlargement processing means causes the component to be displayed in an enlarged manner in an enlarged-display area which is located above or below the layout display area and in which scrolling display in the horizontal direction is possible, among the plurality of enlarged-display areas

According to the configuration, a component to be scrolled in the vertical direction is displayed in an enlarged manner in an enlarged-display area which is located on the right or left side of the layout display area and in which scrolling display in the vertical direction is possible, and a component to be scrolled in the horizontal direction is displayed in an enlarged-display area which is located above or below the layout display area in which scrolling display in the horizontal direction is possible. These enlarged-display areas are different from the layout display area.

Accordingly, the user can cause part of the plurality of components to be displayed in an enlarged-display area so as to read the part of the plurality of components, while checking the layout display of the plurality of components in the layout display area. The enlarged-display area in which the scrolling display in the horizontal direction is possible is set to be located above or below the layout display area, and the enlarged-display area in which the scrolling display in the vertical direction is possible is set to be located on the right or left side of the layout display area. This allows the user to understand easily a position on the screen where the part of the plurality of components is to be displayed in an enlarged manner.

Note that the layout display as described above encompass both (i) determining a positional arrangement of the plurality of components and displaying the plurality of components in accordance with the determined positional arrangement and (ii) simply displaying an image in which the plurality of components are already laid out.

The display control device preferably has a configuration in which (a) the document content includes a plurality of articles and (b) among components that the enlargement processing means has identified as belonging to the same article with reference to article identification information indicative of an article to which each of the plurality of components belongs, the enlargement processing means (i) causes a component, a scroll direction of which has been determined as being a vertical direction, to be displayed in an enlarged manner in an enlarged-display area in which scrolling display in the vertical direction is possible among the plurality of enlarged-display areas and (ii) simultaneously causes a component, a scroll direction of which has been determined as being a horizontal direction, to be displayed in an enlarged manner in an enlarged-display area in which scrolling display in the horizontal direction is possible among the plurality of enlarged-display areas.

According to the configuration, among components belonging to the same article, (i) a component whose scroll direction has been determined as being the vertical direction is displayed in an enlarged manner in the enlarged-display area in which the scrolling display in the vertical direction is possible and (ii), simultaneously, a component whose scroll direction has been determined as being the horizontal direction is displayed in an enlarged manner in the enlarged-display area in which the scrolling display in the horizontal direction is possible.

This allows the user to check a part of components of an article in the enlarged-display area in which the scrolling display in the vertical direction is possible, while checking another part of the components of the article in the enlarged-display area in which the scrolling display in the horizontal direction is possible.

It is preferable that the display control means further include focus processing means for causing an area to be displayed so as to be recognizable to a user, the area being one of (i) the enlarged-display area in which the scrolling display in the vertical direction is possible and (ii) the enlarged-display area in which the scrolling display in the horizontal direction is possible, which one of the enlarged-display areas has been identified, with reference to display order information indicative of a display order of the plurality of components, as displaying in an enlarged manner a component whose display order is earlier than that of a component that is displayed in an enlarged manner in the other of the enlarged-display areas.

According to the configuration, one of (i) the enlarged-display area in which the scrolling display in the vertical direction is possible and (ii) the enlarged-display area in which the scrolling display in the horizontal direction is possible can be displayed so as to be recognizable to the user, the one of the enlarged-display areas displaying in an enlarged manner a component whose display order is earlier than that of a component that is displayed in an enlarge manner in the other one of the enlarged-display areas. This allows the user to recognize easily which document the user should start reading first between documents that are displayed in an enlarged manner in respective two areas.

The display control device may have a configuration in which, when the enlargement processing means causes the plurality of components to be displayed in an enlarged manner in a display order of the plurality of components with reference to display order information indicative of the display order, the enlargement processing means causes the plurality of components to be displayed in only one of (i) an enlarged-display area in which scrolling display in a vertical direction is possible and (ii) an enlarged-display area in which scrolling display in a horizontal direction is possible, among the plurality of enlarged-display areas.

According to the configuration, when the plurality of components are displayed in an enlarged manner in the display order indicated by the display order information, each of the plurality of components is displayed in an enlarged manner in only one of (i) the enlarged-display area in which the scrolling display in the vertical direction is possible and (ii) the enlarged-display area in which the scrolling display in the horizontal direction is possible. For example, in a case where it is determined that a scroll direction of a component, which is subsequent in display order to another component that is being displayed in an enlarged manner in the enlarged-display area in which the scrolling display in the vertical direction is possible, is the horizontal direction, what is displayed in an enlarged manner in the enlarged-display area in which the scrolling display in the vertical direction is possible is cleared (deleted) and the component subsequent in display order is displayed in an enlarged manner in a horizontal enlarged-display area.

That is, according to the configuration, document content including both a component to be scrolled in the vertical direction and a component to be scrolled in the horizontal direction can be read by following what is displayed in either one of (i) the enlarged-display area in which the scrolling display in the vertical direction is possible and (ii) the enlarged-display area in which the scrolling display in the horizontal direction is possible, in which one of the enlarged-display areas enlarged display is being carried out.

The display control device preferably has a configuration in which (a) one article is constituted by a part or whole of the plurality of components and (b) the display control device further includes headline processing means for causing a component to be displayed in the layout display area in a manner distinguishable from other components, the component having been identified, with reference to headline identification information indicative of a component corresponding to a headline of the article constituted by the part or whole of the plurality of components, as corresponding to a headline of an article to which a component that is being caused by the enlargement processing means to be displayed in an enlarged manner belongs.

According to the configuration, a component corresponding to a headline of an article, to which a component being displayed in an enlarged manner belongs, is displayed in the layout display area in a manner distinguishable from other components. This allows the user to (i) recognize the headline of an article which is displayed in an enlarged manner among the articles in the layout display and (ii) simultaneously check contents of the article displayed in an enlarged manner.

The display control device preferably has a configuration in which the enlargement processing means causes an enlarged image of components to be displayed, the components having been identified, with reference to display order information indicative of a display order of the plurality of components, as being successive in display order, the enlarged image showing the components in such a manner that the components are connected to each other in the display order.

According to the configuration, with respect to components that are successive in display order, an enlarged image in which the components are connected to each other in the display order is displayed. That is, enlarged display is performed in a region that extends over two components to be continuously displayed.

Accordingly, the configuration makes it possible to display in an enlarged manner a region extending a plurality of components of document content. For example, in a case where each line or each column of document content is regarded as a component of the document content, a line or a column subsequent to another line or another column that is displayed in an enlarged manner in an enlarged-display area can be displayed in an enlarged manner, immediately after the another line or the another column, in the same enlarged-display.

Further, since the configuration makes it possible to display in an enlarged manner a region extending over a plurality of components, the position of an enlargement region can be moved over a plurality of components. This makes it possible to read the document content while the position of the enlargement region is moved.

The display control device preferably has a configuration in which (a) the document content includes a plurality of articles and (b) in a case where the enlargement processing means detects, on the basis of article identification information indicative of an article to which each of the plurality of components belongs, a selection of a component belonging to an article that is different from an article of a component being displayed in an enlarged manner, the enlargement processing means causes another component to be displayed in an enlarged manner, the another component having been identified, with reference to display order information indicative of a display order of the plurality of components, as having the earliest display order among components of the article to which the selected component belongs.

According to the configuration, when selection of a component of another article is detected, a component whose display order is the earliest among components of the another article is displayed in an enlarged manner. This makes it possible to read the another article from the beginning thereof. Note that a component to be selected of the another article may be a text of the another article, or an image such as a related chart.

The display control device preferably has a configuration in which (a) the document content includes a plurality of articles and (b) in a case where a position of an enlargement region is made to advance further in the document content from a state where a component whose display order is the last in one article is displayed in an enlarged manner, the enlargement processing means causes a component of another article to be displayed in an enlarged manner on the basis of (i) article identification information indicative of an article to which each of the plurality of components belongs and (ii) display order information indicative of a display order of the plurality of components.

According to the configuration, in a case where an enlargement region is made to advance further from a state where a component whose display order is the last in one article is displayed in an enlarged manner, a component of another article is displayed in an enlarged manner.

Accordingly, after the user has read through an article that is displayed in an enlarged manner in an enlarged-display area, the user can go on to read another article in the enlarged-display area by, for example, carrying out an operation of causing the position of the enlargement region to advance further. Note that the another article may be displayed in such a manner that components of the another article are sequentially displayed from a component whose display order is the earliest among the components. In this case, the another article can be read from the beginning thereof.

The display control device preferably has a configuration in which (a) the document content includes a plurality of articles and (b) in a case where a position of an enlargement region is made to advance further in the document content from a state where an end of a component corresponding to a summary of an article is displayed in an enlarged manner, the enlargement processing means causes a component of another article to be displayed in an enlarged manner with reference to (i) article identification information indicative of an article to which each of the plurality of components belongs, (ii) summary identification information indicative of a component corresponding to a summary of each of the plurality of articles, and (iii) display order information indicative of a display order of the plurality of components.

According to the configuration, in a case where the position of the enlargement region is caused to advance further from a state where the end of a component corresponding to a summary is displayed in an enlarged manner, a component of another article is displayed in an enlarged manner.

Accordingly, in a case where the user has finished reading a summary of an article and wants to read another article instead of reading details of the article that the user has finished reading, the reader can go on to read the another article in the enlarged-display area by carrying out an operation of causing the position of the enlargement region to advance further.

Note that the another article may be displayed in such a manner that components of the another article are sequentially displayed from a component whose display order is the earliest among the components. In this case, the another article can be read from the beginning thereof. The another article may also be displayed in such a manner that components of the another article can be sequentially displayed from a component corresponding to a summary of the another article. In this case, the user can continuously read only summaries of the plurality of articles.

It is preferable that the display control means further include related image processing means for causing an image to be displayed in an area different from the one or the plurality of enlarged-display areas, the image having been specified, with reference to associated-image information, as being associated with a component that is being caused by the enlargement processing means to be displayed in an enlarged manner, the associated-image information associating the plurality of components with an image related to the plurality of components.

According to the configuration, an image associated with a component displayed in an enlarged manner is displayed in an area different from the one or the plurality of enlarged-display areas. This allows the user to view simultaneously (i) the image related to the component displayed in an enlarged manner and (ii) the component displayed in an enlarged manner.

The display control device may be realized by a computer. In this case, the present invention encompasses: a control program for the display control device which program causes a computer to operate as the foregoing means of the display control device so that the display control device can be realized by the computer; and a computer-readable storage medium storing the control program therein.

### INDUSTRIAL APPLICABILITY

The present invention is applicable to a device for displaying document content, a device for causing document content to be displayed by another display device, or the like.

### REFERENCE SIGNS LIST

1 electronic book reader (display control device)
20 enlargement processing section (scroll direction determining means, enlargement processing means, focus processing means)
21 display processing section
22 related image processing section (related image processing means
23 headline processing section (headline processing means) article management information (scroll information,
30 article identification information, display order information, summary identification information)
31 content (document content)
32 related chart list (associated-image information)
33 headline list (headline identification information)

1. A display control device which displays part of a plurality of components of document content in an enlarged manner, comprising:
scroll direction determining means for determining, with reference to scroll information, a scroll direction of a component to be displayed in an enlarged manner, the scroll information being indicative of a scroll direction in which each of the plurality of components is scrolled when displayed in an enlarged manner; and
enlargement processing means for causing the component, which is to be displayed in an enlarged manner, to be displayed in an enlarged manner in an enlarged-display area in which scrolling in the scroll direction determined by the scroll direction determining means is possible, among one or a plurality of enlarged-display areas which are different from a layout display area in which layout display of the plurality of components is performed.

2. The display control device as set forth in claim 1, wherein:
in a case where the scroll direction determining means determines that the scroll direction of the component to be displayed in an enlarged manner is a vertical direction, the enlargement processing means causes the component to be displayed in an enlarged manner in an enlarged-display area which is located on the right or left side of the layout display area and in which scrolling display in the vertical direction is possible, among the plurality of enlarged-display areas; and
in a case where the scroll direction determining means determines that the scroll direction of the component to be displayed in an enlarged manner is a horizontal direction, the enlargement processing means causes the component to be displayed in an enlarged manner in an enlarged-display area which is located above or below the layout display area and in which scrolling display in the horizontal direction is possible, among the plurality of enlarged-display areas.

3. The display control device as set forth in claim 1, wherein:
the document content includes a plurality of articles; and
among components that the enlargement processing means has identified as belonging to the same article with reference to article identification information indicative of an article to which each of the plurality of components belongs, the enlargement processing means (i) causes a component, a scroll direction of which has been determined as being a vertical direction, to be displayed in an enlarged manner in an enlarged-display area in which scrolling display in the vertical direction is possible among the plurality of enlarged-display areas and (ii) simultaneously causes a component, a scroll direction of which has been determined as being a horizontal direction, to be displayed in an enlarged manner in an enlarged-display area in which scrolling display in the horizontal direction is possible among the plurality of enlarged-display areas.

4. A display control device as set forth in claim 3, further comprising focus processing means for causing an area to be displayed so as to be recognizable to a user, the area being one of (i) the enlarged-display area in which the scrolling display in the vertical direction is possible and (ii) the enlarged-display area in which the scrolling display in the horizontal direction is possible, which one of the enlarged-display areas has been identified, with reference to display order information indicative of a display order of the plurality of components, as displaying in an enlarged manner a component whose display order is earlier than that of a component that is displayed in an enlarged manner in the other of the enlarged-display areas.

5. The display control device as set forth in claim 1, wherein:
when the enlargement processing means causes the plurality of components to be displayed in an enlarged manner in a display order of the plurality of components with reference to display order information indicative of the display order, the enlargement processing means causes the plurality of components to be displayed in only one of (i) an enlarged-display area in which scrolling display in a vertical direction is possible and (ii) an enlarged-display area in which scrolling display in a horizontal direction is possible, among the plurality of enlarged-display areas.

6. The display control device as set forth in claim 1, wherein:
one article is constituted by a part or whole of the plurality of components; and
the display control device further comprises headline processing means for causing a component to be displayed in the layout display area in a manner distinguishable from other components, the component having been identified, with reference to headline identification information indicative of a component corresponding to a headline of the article constituted by the part or whole of the plurality of components, as corresponding to a headline of an article to which a component that is being caused by the enlargement processing means to be displayed in an enlarged manner belongs.

7. The display control device as set forth in claim 1; wherein:
the enlargement processing means causes an enlarged image of components to be displayed, the components having been identified, with reference to display order information indicative of a display order of the plurality of components, as being successive in display order, the enlarged image showing the components in such a manner that the components are connected to each other in the display order.

8. The display control device as set forth in claim 1; wherein:
the document content includes a plurality of articles; and
in a case where the enlargement processing means detects, on the basis of article identification information indicative of an article to which each of the plurality of components belongs, a selection of a component belonging to an article that is different from an article of a component being displayed in an enlarged manner, the enlargement processing means causes another component to be displayed in an enlarged manner, the another component having been identified, with reference to display order information indicative of a display order of the plurality of components, as having the earliest display order among components of the article to which the selected component belongs.

9. The display control device as set forth in claim 1; wherein:
the document content includes a plurality of articles; and
in a case where a position of an enlargement region is made to advance further in the document content from a state where a component whose display order is the last in one article is displayed in an enlarged manner, the enlargement processing means causes a component of another article to be displayed in an enlarged manner on the basis of (i) article identification information indicative of an article to which each of the plurality of components belongs and (ii) display order information indicative of a display order of the plurality of components.

10. The display control device as set forth in claim 1; wherein:
the document content includes a plurality of articles; and
in a case where a position of an enlargement region is made to advance further in the document content from a state where an end of a component corresponding to a summary of an article is displayed in an enlarged manner, the enlargement processing means causes a component of another article to be displayed in an enlarged manner with reference to (i) article identification information indicative of an article to which each of the plurality of components belongs, (ii) summary identification information indicative of a component corresponding to a summary of each of the plurality of articles, and (iii) display order information indicative of a display order of the plurality of components.

11. A display control device as set forth in claim 1, further comprising related image processing means for causing an image to be displayed in an area different from the one or the plurality of enlarged-display areas, the image having been specified, with reference to associated-image information, as being associated with a component that is being caused by the enlargement processing means to be displayed in an enlarged manner, the associated-image information associating the plurality of components with an image related to the plurality of components.

12. A display method for displaying a part of a plurality of components of document content in an enlarged manner by use of a display control device, the method comprising the steps of:
(a) determining, with reference to scroll information, a scroll direction of a component to be displayed in an enlarged manner, the scroll information being indicative of a scroll direction in which each of the plurality of components is scrolled when displayed in an enlarged manner; and
(b) causing the component, which is to be displayed in an enlarged manner, to be displayed in an enlarged manner in an enlarged-display area in which scrolling in the scroll direction determined in the step (a) is possible, among one or a plurality of enlarged-display areas which are different from a layout display area in which layout display of the plurality of components is performed.

13. (canceled)

14. A non-transitory computer-readable recording medium containing a control program for causing a display control device recited in claim 1 to operate, the control program being configured to cause a computer to function as each of the means.
